(19) United States
(12) Patent Application Publication
(10) Pub. No.: US 2013/0267253 A1
(43) Pub. Date: Oct. 10, 2013

(54) TRIGGER ZONES AND DWELL TIME ANALYTICS

(71) Applicant: ENVIRONMENTAL SYSTEMS RESEARCH INSTITUTE, INC., Redlands, CA (US)

(72) Inventors: Amber L. Case, Portland, OR (US); Aaron D. Parecki, Portland, OR (US)

(21) Appl. No.: 13/741,058

(22) Filed: Jan. 14, 2013

Related U.S. Application Data
(60) Provisional application No. 61/585,776, filed on Jan. 12, 2012.

(51) Int. Cl. H04W 4/02

(52) U.S. Cl. CPC H04W 4/021
USPC 455/456.3

(57) ABSTRACT

Certain embodiments of the invention related to a method of receiving and processing trigger zone and geo-trigger content on a computing device. Trigger zones can be relevant to a current geographic position of the computing device and can be characterized by a time-based boundary and one or more requirements to be satisfied to trigger an event. The computing device can evaluate trigger zones to determine if one the one or more requirements are satisfied and trigger an trigger event if confirmed. In some embodiments, a server computer can generate a dwell-time trigger zone based on an amount of time a computing device spends at a geographic location. The dwell time trigger zone can include trigger zone data corresponding to commercial aspects particular to the geographic location. The server computer can be configured to send the trigger zone and trigger zone data to the computing device for processing.

### CROSS-REFERENCES TO RELATED APPLICATIONS

The present non-provisional U.S. patent application claims benefit under 35 U.S.C. §119 of U.S. Provisional Patent Application No. 61/585,776, filed on Jan. 12, 2012, and entitled “Trigger Zones and Dwell Time Analytics,” which is incorporated by reference in its entirety for all purposes.

### BACKGROUND

The use of geo-fences in commercial applications has become more prevalent as the popularity and access to mobile electronics continues to increase. Geo-fencing can be configured to enable an action to be taken when a device enters or leaves a specific geographical area defined by the geo-fence. Some common uses of geo-fencing may include a to-do list application that can notify a user to buy bread when user nears a grocery store, a department store application configured to notify a user about a current sale on their favorite shirts when at or near a store branch, and more. In summary, user no longer have to launch their favorite department store applications now that mobile devices may be configured to automatically launch when the near any store branch and receive coupons, reminders, or advertisements that can be tailored to specification.

Although there are many useful commercial applications for geo-fencing technologies, there are many problems associated with conventional geo-fence networks. For instance, mobile applications tend to utilize significant power resources when operating geo-fence applications. Some geo-fencing applications may not provide users with content customized to their particular needs. Embodiments of the invention address these and other problems.

### BRIEF SUMMARY

Certain embodiments of the invention related to a method of receiving and processing trigger zone and geo-trigger content on a computing device. Trigger zones can be relevant to a current geographic position of the computing device and can be characterized by a time-based boundary and one or more requirements to be satisfied to trigger an event. The computing device can evaluate trigger zones to determine if the one or more requirements are satisfied and trigger an event if confirmed.

In some embodiments, a server computer can generate a dwell-time trigger zone based on an amount of time a computing device spends at a geographic location. The dwell time trigger zone can include trigger zone data corresponding to commercial aspects particular to the geographic location. The server computer can be configured to send the trigger zone and trigger zone data to the computing device for processing.

In certain embodiments, a method includes determining, on a computing device, a current geographic position and sending position data to a server, where the position data corresponding to the current geographic position. The method further includes receiving, from the server, one or more trigger zones relevant to the position data, where each trigger zone characterized by a time-based boundary and one or more requirements to be satisfied to trigger an event. The method can further include determining whether the computing device is located within a time-based boundary of a first trigger zone of the one or more trigger zones, determining if one or more requirements of the first trigger zone is satisfied, and triggering an event associated with the first trigger zone. In some cases, the method can include outputting a notification on the computing device indicating that the one or more requirements has been met. The method can be performed by a computing device that includes a processor and a computer-readable storage medium coupled to the processor, where the computer readable storage medium comprises code executable by the processor for implementing the method.

In some cases, one or more trigger zones can be located within a threshold area relative to the current geographic position. Trigger zones can include a reference point, and the time-based boundary can be defined by an estimated travel time from the time-based boundary to the reference point. In certain embodiments, the trigger zones can be preselected or subscribed to, such that only those trigger zones that are preselected or subscribed to are received from the server.

Certain embodiments of the invention include a method comprising determining, on a computing device, a current approximate geographic position, and sending a first position data to a server, where the first position data corresponding to the current approximate geographic position. The method can include receiving, from the server, a request for an accurate geographic position of the computing device, and determining, on a computing device, a current accurate geographic position. The current accurate geographic position can be more accurate than the approximate geographic position. The method further includes sending a second position data to a server, where the second position data corresponds to the current accurate geographic position, and receiving, from the server, one or more trigger zones relevant to the position data. Each trigger zone can be characterized by a time-based boundary and one or more requirements to be satisfied to trigger an event.

In some cases, the method further includes determining whether the computing device is located within a time-based boundary of a first trigger zone of the one or more trigger zones, determining if one or more requirements of the first trigger zone is satisfied, and triggering an event associated with the first trigger zone. The one or more trigger zones can be within a threshold area relative to the current geographic position.

Certain embodiments of the invention relate to a method including receiving position data from a computing device, where the position data corresponds to a current geographic position of the computing device, and determining whether one or more trigger zones are within a threshold area relative to the position data. The method further includes sending trigger zone data to the computing device, where the trigger zone data includes one or more trigger zones with the threshold area relative to the position data. Each trigger zone can be characterized by a time-based boundary and one or more requirements to be satisfied to trigger an event. The one or more requirements can include digital content configured to be interacted with via the computing device. The method further includes detecting an amount of interaction made by the computing device for each of the trigger zones and assigning each of the one or more trigger zones with a weighted value based on the amount of interaction. The higher weighted values can indicate higher amounts of interaction, and the lower weighted values can indicate lower amounts of interaction. The trigger zone data can include only sending trigger zones above a threshold weighted value to the computing device.

Further embodiments of the invention are directed to a method include determining how much time the computing device spends at one or more geographic locations, and generating a dwell-time trigger zone including dwell-time trigger zone data based on both an amount of time spent at the geographic location, and on data associated with the geographic location. The location based data can correspond to commercial aspects particular to the geographic location. In some cases, sending trigger zone data to the computing device further includes sending dwell-time trigger zone data.

In yet further embodiments, a method includes receiving first position data from a computing device, where the first position data corresponds to a current approximate geographic position of the computing device. The method further includes determining whether one or more trigger zones are within a threshold area relative to the first position data, sending a request for an accurate geographic position of the computing device, and receiving, from the computing device, second position data. The second position data can correspond to a current accurate geographic position of the computing device. In some cases, the method can include sending trigger zone data to the computing device, where the trigger zone data including one or more trigger zones with the threshold area relative to the second position data. Each trigger zone can be characterized by a time-based boundary, and one or more requirements to be satisfied to trigger an event.

### BRIEF DESCRIPTION OF THE DRAWINGS

FIG. 1A is a simplified diagram illustrating aspects of a geo-fence system, according to an embodiment of the invention.

FIG. 1B is a simplified diagram illustrating aspects of a geo-fence system, according to an embodiment of the invention.

FIG. 2A is a simplified diagram illustrating a geo-fencing pattern based on a distance for a geo-fence system, according to an embodiment of the invention.

FIG. 2B is a simplified diagram illustrating a geo-trigger pattern based on travel time for a geo-trigger system, according to an embodiment of the invention.

FIG. 3A is a simplified diagram illustrating aspects of a trigger zone request and retrieval process, according to an embodiment of the invention.

FIG. 3B is a simplified diagram illustrating aspects of a trigger zone request and retrieval process, according to an embodiment of the invention.

FIG. 4 is a simplified flow diagram illustrating a method for retrieving and evaluating trigger zone data, according to an embodiment of the present invention.

FIG. 5A is a simplified diagram illustrating aspects of a trigger zone request and retrieval process with improved battery efficiency, according to an embodiment of the invention.

FIG. 5B is a simplified diagram illustrating aspects of a trigger zone request and retrieval process with improved battery efficiency, according to an embodiment of the invention.

FIG. 5C is a simplified diagram illustrating aspects of a trigger zone request and retrieval process with improved battery efficiency, according to an embodiment of the invention.

FIG. 5D is a simplified diagram illustrating aspects of a trigger zone request and retrieval process with improved battery efficiency, according to an embodiment of the invention.

FIG. 5E is a simplified diagram illustrating aspects of a trigger zone request and retrieval process with improved battery efficiency, according to an embodiment of the invention.

FIG. 6 is a simplified flow diagram illustrating a method for retrieving and evaluating trigger zone data with improved battery efficiency, according to an embodiment of the invention.

FIG. 7 is a simplified flow diagram illustrating a method for delivering trigger zone data, according to an embodiment of the invention.

FIG. 8A is a simplified flow diagram illustrating a method for defining a trigger zone based on dwell times, according to an embodiment of the invention.

FIG. 8B is a simplified flow diagram illustrating a method 850 for customizing the delivery of trigger zone content that is increasingly relevant to a location, according to an embodiment of the invention.

FIG. 8C illustrates a series of dwell time based data logs, according to an embodiment of the invention.

FIG. 9 depicts a dwell time heat map, according to an embodiment of the invention.

FIG. 10 depicts a dwell time map illustrating a number of trigger zones for a user, according to an embodiment of the invention.

FIG. 11 depicts an application of dwell time analytics on a computing device, according to an embodiment of the invention.

FIG. 12 illustrates a dwell time graph updated at 5 second intervals, according to an embodiment of the invention.

FIG. 13 depicts an image of a trigger zone based game, according to an embodiments of the invention.

FIG. 14 displays real-time publically geo-coded data pushed to a user based on their current location, according to an embodiment of the invention.

FIG. 15 is a simplified block diagram illustrating aspects of trigger zone system, according to an embodiment of the invention.

FIG. 16 is a simplified flow diagram illustrating aspects of a method for retrieving trigger zone data on a mobile device, according to an embodiment of the invention.

FIG. 17 is a simplified flow diagram illustrating aspects of a method of retrieving trigger zones on a micro-chip, according to an embodiment of the invention.

FIG. 18 illustrates a computer system according to an embodiment of the invention.

### DETAILED DESCRIPTION

Embodiments of the invention are generally directed to systems, architectures of the systems, and methods for supporting geo-triggering, and dwell-time analytics.

Certain embodiments of the invention related to a method of receiving and processing trigger zone and geo-trigger content on a computing device. Trigger zones can be relevant to a current geographic position of the computing device and can be characterized by a time-based boundary and one or more requirements to be satisfied to trigger an event. The computing device can evaluate trigger zones to determine if one the one or more requirements are satisfied, and trigger a trigger event if confirmed.

In some embodiments, a server computer can generate a dwell-time trigger zone based on an amount of time a computing device spends at a geographic location. The dwell time trigger zone can include trigger zone data corresponding to commercial aspects particular to the geographic location. The server computer can be configured to send the trigger zone and trigger zone data to the computing device for processing.

Geo-Fences

Geo-fences can be virtual perimeters applied to a real-world geographic area. For example, geo-fences can be configured as a predefined set of boundaries, such as at school attendance zones, restricted areas, neighborhood boundaries, and the like. Geo-fences can also be dynamically generated and may be defined by a given radius around a store, vehicle, or point location, etc. Conventionally, when a location-aware computing device of a location-based service user enters or exits a geo-fenced area, the computing device typically receives a generated notification (e.g., push messaging, e-mail, SMS messaging, twitter feed, etc.) that may provide information about the location of the computing device, information related to the location of the computing device, or other type of message, cue, or indication as would be known by one of ordinary skill in the art. For example, some applications may include commercial services (e.g., alerting the user to an on-going sale at a nearby department store), emergency or security services, or any desired application. Alternative embodiments can include generating notifications when a computing device leaves the geo-fenced area (e.g., alerting parents when a child leaves a designated area, etc.). In some cases, geo-fences can be customizable, thus allowing users of the geo-fencing systems to establish zones around places of work, customers sites, secure areas, and the like.

Geo-fencing can be used in applications (e.g., hardware, firmware, software, etc.) employing telematics. Telematics include the integrated use of telecommunications and informatics, such as sending, receiving, and storing information via a telecommunication device (e.g., mobile phones) in conjunction with initiating control on remote objects, devices, vehicles, or the like.

Some non-limiting examples of a location-aware computing devices include mobile phones, tablet computers, notebook computers, desktop computers, personal digital assistants (PDAs), or other device with global positional system (GPS) capabilities that are configured to track a current real-time location.

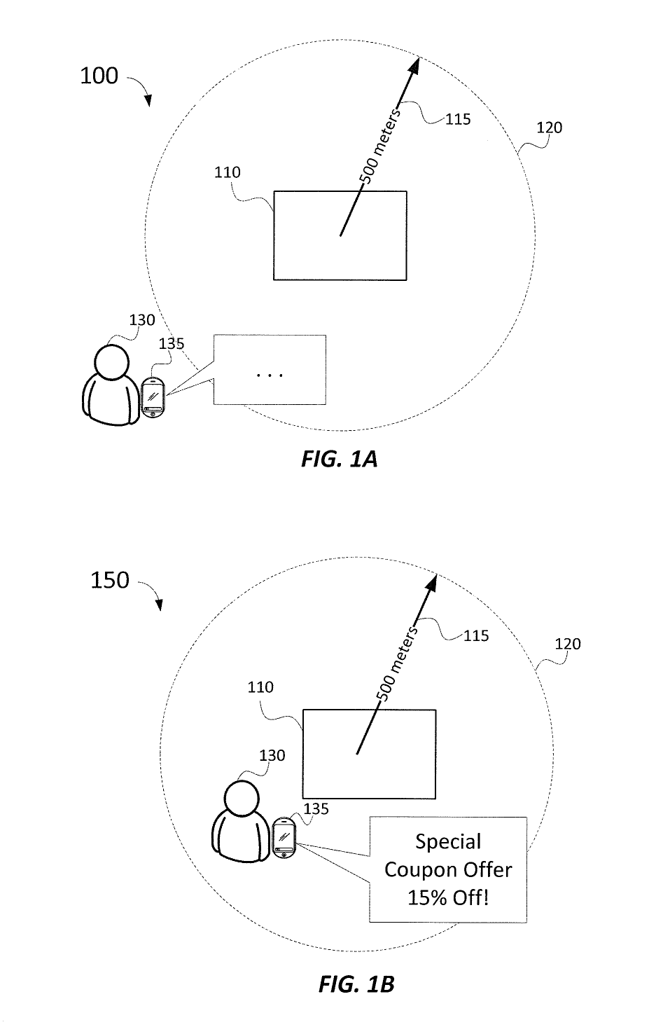

FIGS. 1A and 1B depict simplified diagrams illustrating aspects of a geo-fence system 100, according to certain embodiments of the invention. The geo-fence system 100 includes a geo-fence transmission system 110, a geo-fence boundary 120, and a user 130 with a mobile computing device 135. Mobile computing device 135 can be configured to display data broadcast within the geo-fence boundary 120. In this example, geo-fence boundary 120 has a 500 meter radius, however any suitable size or shape of the geo-fence boundary 120 can be used.

In certain embodiments, geo-fence transmission system 110 creates geo-fence boundary 120. Any suitable data content can be transmitted within the geo-fence boundary 120 including, but not limited to, SMS text messaging, email, twitter messages, file transfers, and the like. For example, geo-fence transmission system 110 may transmit or broadcast coupon data or special deals to entice nearby users to shop at a particular store. Referring to FIG. 1A, user 130 and computing device 135 are outside of geo-fence boundary 120, thus no data is displayed on computing device 135. Referring to FIG. 1B, user 130 and computing device 135 are within geo-fence boundary 120, and the computing device receives the data content transmitted by geo-fence transmission system 110 and displays the message to the user.

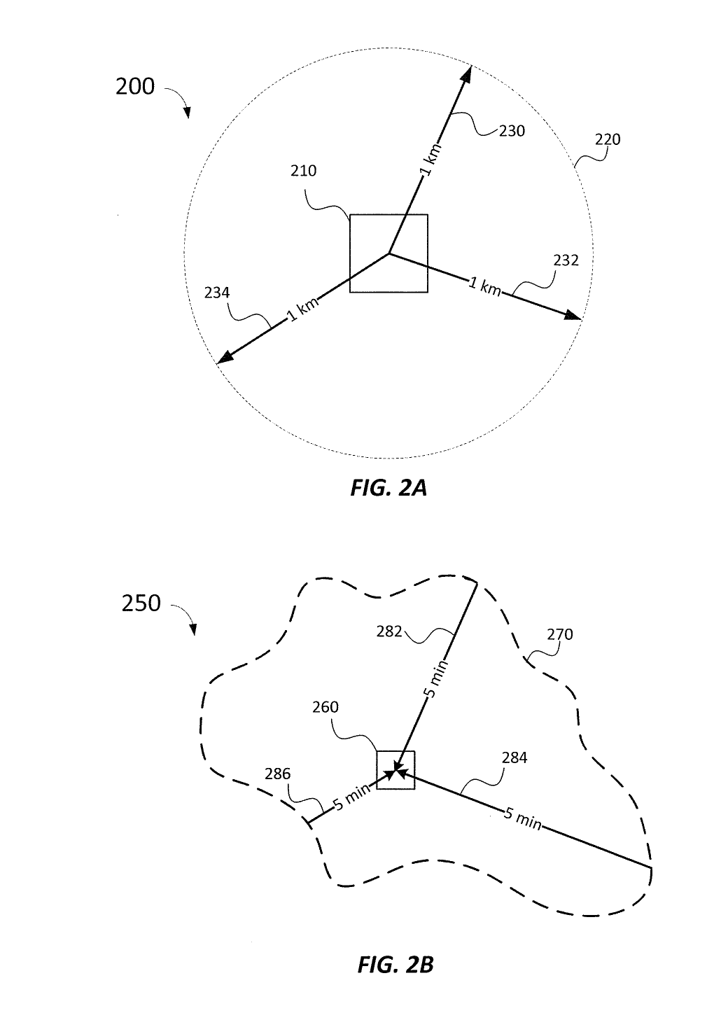

FIG. 2A is a simplified diagram illustrating a geo-fencing pattern based on a distance for a geo-fence system 200, according to an embodiment of the invention. FIG. 2A includes a geo-fence transmission system 210, a geo-fence boundary 220, and radii 230, 232, and 234. Geo-fence transmission system 210 typically broadcasts or delivers data (e.g., SMS, email, alerts, data files, etc.) to GPS enabled computing devices as they cross and enter the geo-fence boundary 220. Transmission system 210 can be a fixed or mobile unit configured to dynamically generate a broadcast region within geo-fence boundary 220 defined by a given radius (e.g., omnidirectional transmission) or may be directional. As shown in FIG. 2A, geo-fence boundary 220 has a 1 km radius in all directions. Although geo-fence boundary 220 is depicted as circular, other shapes, sizes, and combinations of boundary patterns may be used.

Geo-Triggers and Trigger Zones

Geo-fences are typically defined in Euclidian terms, such as an outline or polygon, a distance from a point or set of points, or the like. However, boundaries defined by travel time (e.g., 5 minutes away), dwell time (e.g., the amount of time spent at a location), or other temporally based boundaries cannot easily be defined in Euclidian terms or realized with geo-fencing systems. To illustrate, a geo-fence boundary based on a travel time may have very different travel times depending on a direction of approach. For example, a first driver approaching from a first direction may have a slow and indirect route due to one-way streets, detours, or numerous traffic lights, while a second driver approaching form a second direction may have a quick and direct route due to highway access and little traffic congestion. In these situations, “trigger zones” or “geo-triggers” can be better suited to create boundaries based on temporal distances and the like.

FIG. 2B is a simplified diagram illustrating a geo-trigger pattern based on travel time for a geo-trigger system 250, according to an embodiment of the invention. FIG. 2B includes a geo-trigger transmission system 260, a geo-trigger boundary 270 with travel times 282, 284, and 286. Geo-trigger transmission system 210 typically broadcasts (e.g., delivers, distributes, etc.) data and/or messages (e.g., SMS, email, alerts, data files, etc.) to GPS-enabled computing devices or trigger an action (e.g., telematics) via computing device as they cross and enter geo-trigger boundary 220. Geo-trigger boundary 270 represents a travel time (e.g., 5 minutes via motor vehicle) from boundary 270 to a reference point (e.g., transmission system 260).

Referring to FIG. 2B, geo-trigger boundary 270 has an amorphous travel time boundary that can be shaped based on a variety of factors. For example, boundary 270 can be defined by data indicating different types of roads (e.g., highway, roadway, bridge, etc.), road conditions (e.g., flat, hilly, windy, pavement, dirt road, etc.), traffic conditions, the time of day, weather conditions (e.g., temperature, precipitation, etc.), calendar day (e.g., weekday, weekend, holiday), geography and topology, type of transportation, traffic laws and rules (e.g., speed limit, stop sign location, traffic light characteristics, etc.) and any other suitable metric. The data may be updated in real-time, periodically, or based on previous data (e.g., historical boundary 270 patterns). As a result, a 5 minute travel time from a first direction may be substantially further away than a 5 minute travel time from a second direction. To illustrate, travel time 286 may represent a 5-minute travel time by car during rush hour traffic on a heavily congested highway, hence its short distance from the reference point (e.g., transmission system 260). On the other hand, travel time 284 may represent a 5-minute travel time through open roads, little traffic, and relatively high speed limits, resulting in a much farther distance traveled during that time frame.

In some embodiments, geo-trigger (i.e., trigger zone) boundary 270 may change iteratively during periodic updates, or it may be dynamically adjusted in real-time. Any number or combination of data types can be used to define boundary 270, which can result is varying levels of travel time accuracy. In some embodiments, geo-triggers, or “trigger zones,” differ from geo-fences in a number of ways. As shown in FIG. 2B and described above, trigger zones do not necessarily have hard and/or fixed edges and can vary based on myriad conditions. Trigger zones can be applied to both fixed and mobile assets. For example, geo-trigger transmission system 260 can establish a trigger zone on a moving vehicle or in a fixed location (e.g., public school). As described above, trigger zones can be defined by metrics other than geography (i.e., time) and can take other factors into account such as previous location history.

The system depicted in FIG. 2B illustrates one embodiment configured to send or display a message on the computing device, transfer data (e.g., to the computing device), or trigger an action (e.g., on or in conjunction with a computing device) in response to crossing a boundary based on an approximated travel time with respect to a reference point or region. However, any number of metrics (e.g., time-based metrics) can be used to establish geo-trigger boundary 270. Furthermore, the geo-trigger boundary 270 may include time-based metrics that do not relate to distance. For example, some geo-trigger boundaries may only consider a time of the day to perform (i.e., trigger, execute, etc.) an action. For example, a message may be pushed to all subscribing computer devices in a given area or region after a certain time of the day. In further embodiments, the time-based message may be pushed to subscribing devices in a region a geo-trigger boundary defined by a second metric (e.g., travel time). For example, a user may wish to have his home HVAC system turned on his way home from work. In that case, the geo-trigger boundary may be based on the travel time (e.g., 20 minutes from home) and the time of day (e.g., after 5 p.m.) to ensure that his home is at a desired temperature by the time he arrives.

Many other metrics that can be used for determining when to send a message or trigger an action as would be appreciated by one of ordinary skill in the art with the benefit of this disclosure. Metrics can include the distance from a location or plurality of locations, a time of day, the speed of an asset (e.g., a mobile phone traveling in a vehicle), a previous behavior (e.g., alerting a user or third party when the subscribing mobile phone enters a region or location not previously entered), and the like.

Geo-trigger or trigger zone content can be associated with a user in a number of ways. For example, the user can access and/or receive trigger zone content by subscribing to the user, user layer, 3^{rd} party, or has a relationship with one or more of those entities. In such cases, the user layer or third party can set trigger zone content that will be delivered to the user. For example, the user can access and/or receive trigger zone content by subscribing to the user's layer, or third party layer, or have a relationship with one or more of those entities. A layer is a collection of trigger rules or geo-data that can be defined by the user or a third party, and can be subscribed to by one or more users or groups. In such cases, the user's layer or third party layer can contain trigger zone content that can be delivered to the user. Furthermore, certain embodiments can include content, actions, and/or triggers occurring or being set by a user, rather than simply pushing advertising content, as typically done with geo-fence technologies. Recommendations, deals, multi-media and other distribution schemes can have significantly broader applications than advertising alone.

Retrieving Trigger Zone Data

Trigger zones and geo-triggers can be virtual perimeters applied to a real-world geographic area. The perimeters or geo-trigger boundaries (i.e., trigger zone boundaries) can be based on temporal parameters (e.g., travel time, speed), non-Euclidian parameters (e.g., temperature, pattern changes, dwell-time analytics, etc.), and the like. Typically, when a location-aware computing device enters or exits a trigger zone area, the computing device can receive a generated notification (e.g., push, e-mail, SMS messaging, telematics data, audio or video cue, phone call, buzz and/or vibrate or any other notification type, etc.) that may provide information about the location of the computing device, information related to the location of the computing device, or other type of message, cue, or indication as would be known by one of ordinary skill in the art.

Trigger zone data can include the trigger zone boundaries and trigger zone content. Trigger zone content may include one or more requirements to be satisfied to trigger an event. For example, when a computing device enters a trigger zone boundary, a message may be displayed on the computing device (e.g., alert the user that they are entering a restricted area), a telematics function may be executed (e.g., the computing device auto-uploads photos and/or music files to a server computer), or other function as would be appreciated by one of ordinary skill in the art with the benefit of this disclosure.

In some embodiments, trigger zone data can be preloaded on a computing device, such that the computing device can determine whether it is traversing a particular trigger zone boundary, and evaluate whether the trigger zone requirements are being met. However, in some regions there may be hundreds if not thousands of trigger zones with associated trigger zone data that can require significant storage and processing requirements. Certain embodiments utilize a remote server configured to store trigger zone data and operable to wirelessly transfer the trigger zone data that may be local to the requesting computing device. In some cases, trigger zone data can be automatically sent from the server to the computing devices without requiring an initial request from the computing device. The automatic sending can be based on a current geographic position of the computing device and the trigger zones in the vicinity.

In alternative embodiments, the computing device can request local trigger zone data from a remote server configured to store trigger zone data based on a current, previous, or designated geographic position. The server may send all trigger zones local to the computing device or within a threshold boundary. In some cases, a user may opt-in to certain trigger zone data such that only trigger zones that are of interest to the user will be delivered upon request. Once a computing device receives trigger zone data, it can store be stored and evaluated as needed.

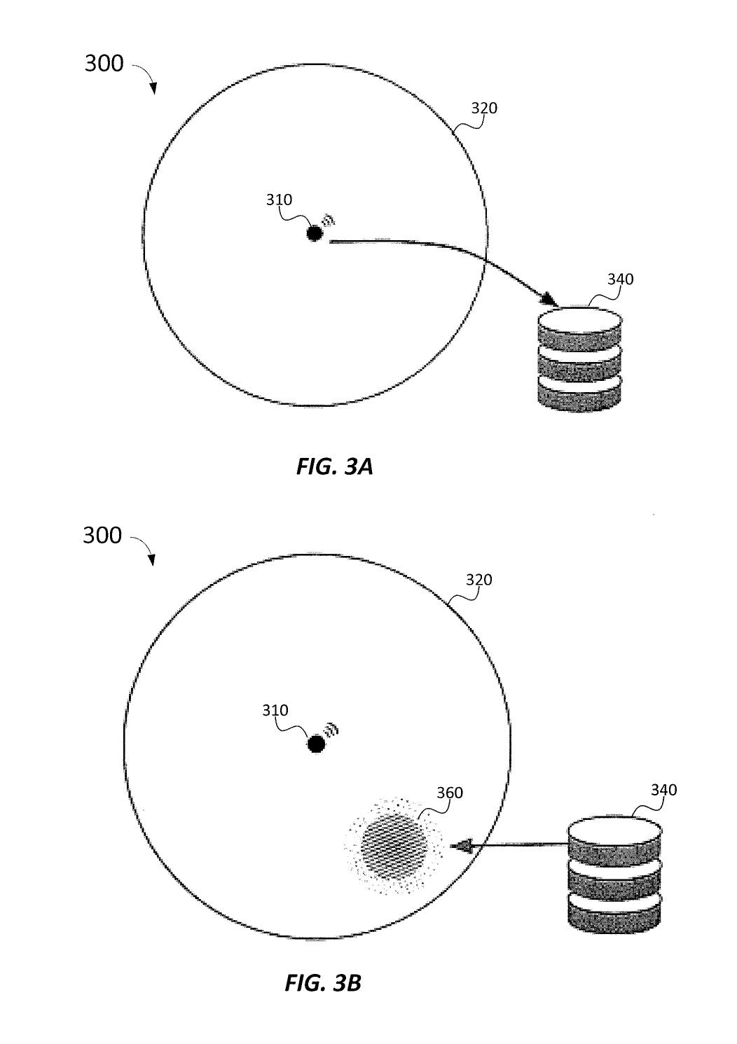

FIG. 3A is a simplified diagram illustrating aspects of a trigger zone request and retrieval process 300, according to an embodiment of the invention. FIG. 3A includes computing device 310, an approximate location 320 of the electronic device 310, and a server computer 340. As shown in FIG. 3A, computing device 310 determines its current geographic location 320 (e.g., via on-board GPS resources) and sends it to server 340. The current geographic location 320 can be an approximate location, a precise location, or any desired resolution. Computing device 310 can optionally send a request for local trigger zones and trigger zone data. However, sending the current geographic location of the computing device can inherently include a request for local trigger zones, according to certain embodiments of the invention. The computing device may include additional trigger zone request parameters such as a designated maximum number of trigger zones, a particular area relative to the current geographic position, and the like. In some cases, additional trigger zone request parameters can be predetermined or designated at a different time. Furthermore, a user can limit the number of trigger zones returned by subscribing or opting into certain types, categories, or individual trigger zones, etc. Alternatively, users can opt-out of certain trigger zones.

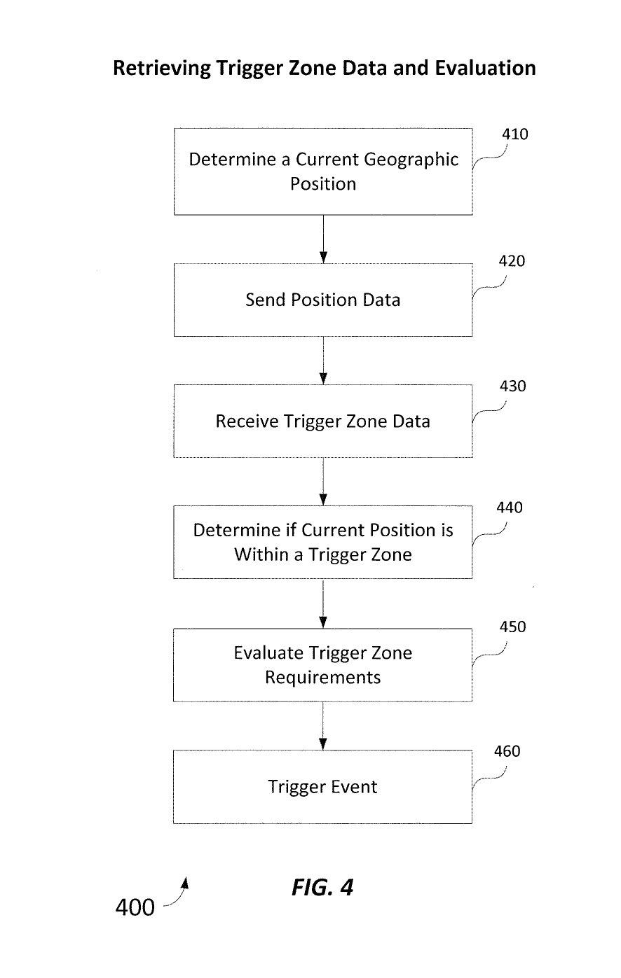

FIG. 3B is a simplified diagram illustrating aspects of a trigger zone request and retrieval process 300, according to an embodiment of the invention. FIG. 3B includes the computing device 310, location 320, and server computer 340 of FIG. 3A, as well as trigger zone 340. In response to receiving a geographic location of a computing device, as shown in FIG. 3A, server computer 340 sends trigger zone data 360 back to electronic device 310. Electronic device 310 stores trigger zone data 360 and can determine whether the trigger zone requirements are met. For example, computer device 310 can determine whether its current location is within the trigger zone boundary of trigger zone 360. The computing device can subsequently evaluate the trigger zone requirements to determine whether to trigger an associated event (e.g., display a message on the computing device). In alternative embodiments, server 340 may determine whether computing device 310 satisfies the requirements of any local trigger zones based on the received location data. In such cases, server 340 can trigger the event (e.g., send an SMS message to the computing device, send a telematics-based instruction to a target entity associated with the trigger zone, send an email, etc.). The process depicted in FIGS. 3A-3B is further discussed below with reference to FIG. 4.

Computing device 310 (electronic device 310) can be any suitable GPS-capable computing device configured to receive, process, and/or respond to trigger zone data (e.g., trigger zone boundaries, content, etc.), such as a mobile phone, PDA, tablet computer, laptop computer, and the like.

Server computer 340 can be a single powerful computer or a cluster of computers. For example, the server computer can be a mainframe computer, a minicomputer cluster, or multiple servers functioning locally or remotely as a single unit.

FIG. 4 is a simplified flow diagram illustrating a method 400 for retrieving and evaluating trigger zone data, according to an embodiment of the present invention. Method 400 can be performed by processing logic that may comprise hardware (circuitry, dedicated logic, etc.), software (such as is run on a general purpose computing system or a dedicated machine), firmware (embedded software), or any combination thereof. In one embodiment, method 400 can be performed by the computing device 310 of FIG. 3A.

At 410, method 400 begins with computing device 310 determining its current geographic position. The current geographic position can be an approximate location (e.g., accuracy within 5 km), a precise location (e.g., accuracy 10 m), or any suitable accuracy.

At 420, computing device 310 sends position data to server computer (“server”) 340. The position data can include the current geographic position of the computing device. Server computer 430 receives the position data and determines whether there is any trigger zone data within a threshold area relative to the position data. Server computer 340 then sends the trigger zone data to computing device 310.

At 430, computing device 310 receives the trigger zone data from server computer 430. The trigger zone data may include all trigger zone data within a predetermined or threshold distance from computing device 310. In alternative embodiments, computing device 310 may only receive trigger zone data for trigger zones or categories thereof that were opted into or subscribed to.

At 440, computing device 310 determines if its current position is within a trigger zone boundary 360. The trigger zone boundary 360 can be based on temporal parameters (e.g., travel time, speed), non-Euclidian parameters (e.g., temperature, pattern changes, dwell-time analytics, etc.), and the like, as previously described.

At 450, if computing device 310 determines that its current geographic position is within one or more trigger zone boundaries, computing device 310 evaluates the trigger zone requirements for each of those trigger zone boundaries. As an illustration, an area close to a number of public schools may have a reduced speed limit during specific hours of the day. A trigger zone requirement may include rules requiring that drivers with 5 minutes from the public school locale (i.e., the trigger zone boundary) must travel at or below the reduced speed limit during certain specific hours. In this case, at 450, computing device 310 determines if the speed of the driver (and computing device 310), is at or below the reduced speed limit when the computing device is within 5 minutes from the public school locale. The trigger zone requirements can be include any suitable rules to be satisfied, as would be appreciated by one of ordinary skill in the art with the benefit of this disclosure.

At 460, if the trigger zone requirements have been met, computing device 310 triggers a trigger zone event. In the example given above with respect to 450, a trigger zone event may include alerting the driver (e.g., by alarm or messaging service) that their current speed is too high and children may be placed at greater risk. It should understood that any type of event can be triggered using trigger zones, as would be appreciated by one of ordinary skill in the art, and any examples provided herein are used merely for the purpose of illustration and should in no way be construed as limiting or all inclusive.

It should be appreciated that the specific steps illustrated in FIG. 4 provide a particular method of retrieving trigger zone data from a remote server, according to an embodiment of the present invention. Other sequences of steps may also be performed according to alternative embodiments. For example, alternative embodiments of the present invention may perform the steps outlined above in a different order. Moreover, the individual steps illustrated in FIG. 4 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of method 400.

Retrieving Trigger Zone Data and Battery Conservation Techniques

Most electronic devices that have an in-device location service have problems with battery life. According to certain embodiments, new ways of managing battery life are illustrated and described herein.

In one embodiment, computing device 310 downloads content for an approximate region from server 340 and saves it in memory (e.g., cache, system RAM, etc.). Then, using the in-device location service (e.g., GPS), the computing device 310 delivers the stored content by a display method (e.g., SMS, e-mail, telematics, push, audio or video cue, phone call, buzz/vibrate, or any suitable notification type) or performs an action (e.g., telematics) in real-time when the trigger zone boundary is breached. The content can be delivered without having to call server 340. In alternative embodiments, the server may perform some or all of the functions of content delivery. In either case, GPS functions tend to draw significant amounts of power from mobile devices. By downloading trigger zone data for a larger approximate location, GPS requests can be significantly reduced, thus potentially extending the battery life on the computing device.

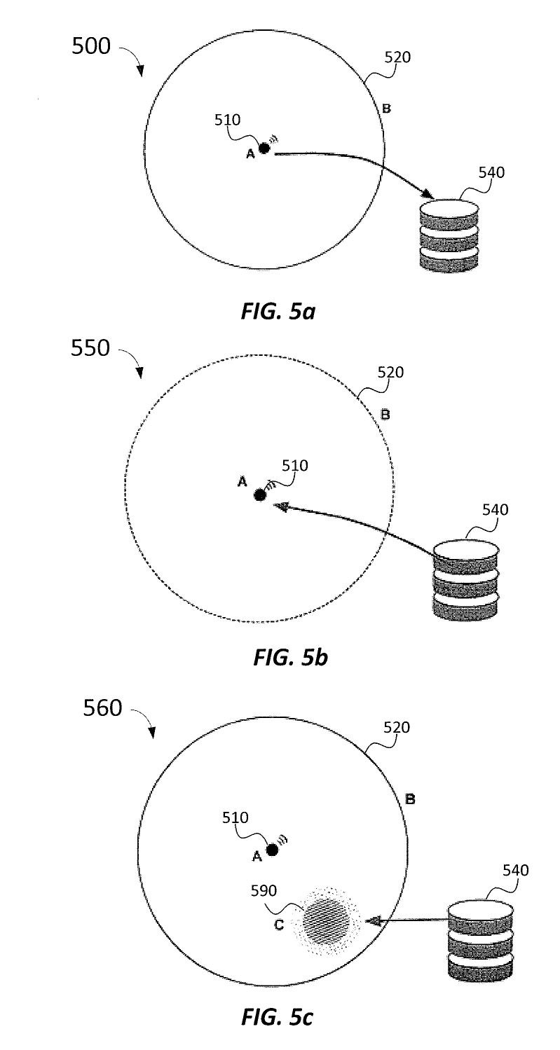

In another embodiment, computing device 310 tells server 340 its approximate location (e.g., of radius ‘w’), and server 340 finds any nearby trigger zones within the radius ‘w’ of the computing device 310. The server then uploads the location metadata of that content to computing device 310. If there are trigger zones within radius ‘w’, the server requests a more accurate position of radius ‘v’ from computing device 310, where the radius ‘v’ is more accurate than radius ‘w.’ Server 340 then sends the trigger zones 360 within radius ‘v’ to computing device 310, where it is saved into memory and evaluated by computing device 310. Alternatively, server 340 can use the more accurate position (i.e., radius v) to check if it should run an evaluation of any of the trigger zone requirements in any applicable trigger zones. These embodiments and others are described below with respect to FIGS. 5A-7.

Although many of the embodiments described herein discuss a particular location of computing device 310, some alternative embodiments may perform the trigger zone delivery and evaluation methods with respect to a location of an object, entity, or area that may be at a different location than computing device 310. For instance, computing device 310 may be used to identify the GPS coordinates of a particular object or area, and receive/evaluate trigger zones associated with the location of the particular object or area.

FIG. 5A is a simplified diagram illustrating aspects of a trigger zone request and retrieval process 500 with improved battery efficiency, according to an embodiment of the invention. FIG. 5A includes computing device 510, an approximate location 520 of the electronic device 310, and a server computer 540. As shown in FIG. 5A, computing device 510 determines its rough geographic location (e.g., via on-board GPS resources) and notifies server 540. Computing device 510 may include additional trigger zone request parameters such as a designated a maximum number of trigger zones, a particular area relative to the current geographic position, and the like. In some cases, additional trigger zone request parameters can be predetermined or designated at a different time. Furthermore, a user can limit the number of trigger zones returned by subscribing or opting into certain types, categories, or individual trigger zones, etc. Alternatively, users can opt-out of certain trigger zones.

FIG. 5B is a simplified diagram illustrating aspects of a trigger zone request and retrieval process 550 with improved battery efficiency, according to an embodiment of the invention. FIG. 5B includes computing device 310, location 320, and server computer 540 of FIG. 5A. In response to receiving a geographic location of a computing device 510, as shown in FIG. 5A, server computer 340 determines that there are no nearby trigger zones in the approximate area of computing device 510. Server computer 540 then responds to computing device 510 indicating that there is no nearby trigger zone content. As such, a more precise location is not requested from computing device 510. Thus, computing device 510 can perform fewer GPS location assessments in areas of no trigger zone content, thus preserving its internal battery life.

FIG. 5C is a simplified diagram illustrating aspects of a trigger zone request and retrieval process 560 with improved battery efficiency, according to an embodiment of the invention. FIG. 5C includes the computing device 510, location 520, and server computer 540 of FIG. 5A, as well as trigger zone 590. In response to receiving the approximate geographic location of computing device 510, as shown in FIG. 5A, server computer 540 detects that there are nearby trigger zones in the approximate area of computer device 510. The server computer then responds to the computer device 510 and indicates that there is nearby content. At this point, only server 540 is aware of the location of the trigger zone content.

FIG. 5D is a simplified diagram illustrating aspects of a trigger zone request and retrieval process 570 with improved battery efficiency, according to an embodiment of the invention. FIG. 5D includes the computing device 510, location 520, server computer 540, and trigger zone 590, of FIG. 5C. Because there are trigger zones in the approximate area of computing device 510, server 540 sends trigger zone content to computing device 510 to be stored, along with delivery rules (i.e., trigger zone requirements) associated with the trigger zone. Server computer 540 then requests more accurate location data from computing device 510. Computing device 510 uses its internal location services (e.g., GPS functions) to determine its location more accurately. Next, the trigger zone requirements are evaluated by server computer 540. If the trigger zone requirements are satisfied, the trigger zone content (e.g., SMS, e-mail, etc.) is delivered to computing device 510 (e.g., for display). If the trigger zone requirements are not met, then computing device 510 stores the trigger zone content and delivers it content once the trigger zone requirements are met. In this example, server 540 evaluates the trigger zone requirements and delivers trigger zone content (e.g., SMS, email, etc.) to the computing device 510 accordingly. In alternative embodiments, server computer 540 merely sends the trigger zone data within the more accurate location to the computing device 510, thus allowing computing device 510 to evaluate the trigger zone requirements and deliver the trigger zone content.

FIG. 5E is a simplified diagram illustrating aspects of a trigger zone request and retrieval process 580 with improved battery efficiency, according to an embodiment of the invention. FIG. 5E includes computing device 510, location 520, server computer 540, and trigger zone 590, of FIGS. 5C-5D. FIG. 5E is similar to 5D, with the exception that computing device 510 can be within the delivery metadata specified by the trigger zone, causing the content to be delivered to computing device 510.

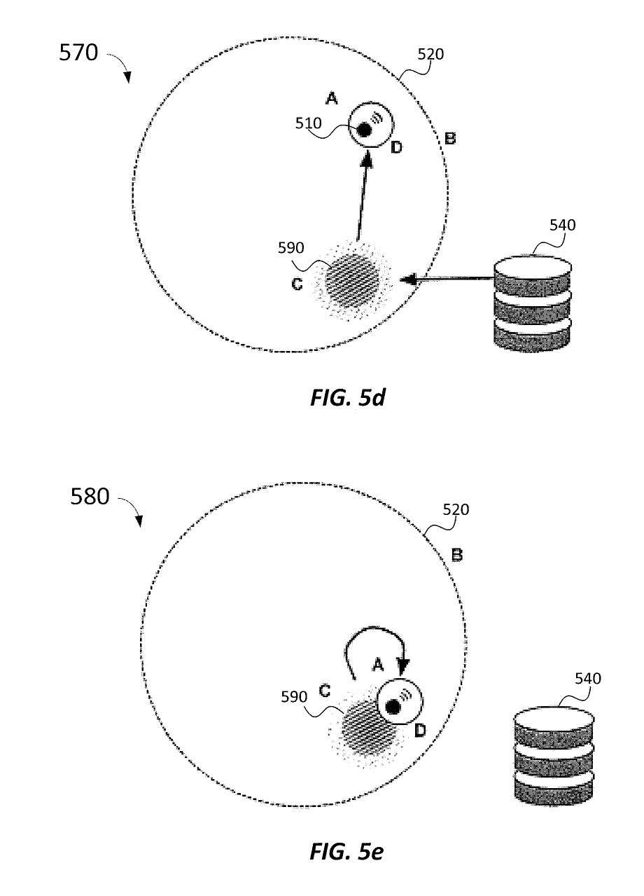

FIG. 6 is a simplified flow diagram illustrating a method 600 for retrieving and evaluating trigger zone data with improved battery efficiency, according to an embodiment of the present invention. Method 600 can be performed by processing logic that may comprise hardware (circuitry, dedicated logic, etc.), software (such as is run on a general purpose computing system or a dedicated machine), firmware (embedded software), or any combination thereof. In one embodiment, method 600 can be performed by the computing device 510 of FIGS. 5A-E.

At 610, method 600 begins with a computing device 510 determining its current approximate geographic position.

At 620, computing device 510 sends first position data to a server computer 540. The first position data can include the current approximate geographic position of the computing device. Server computer 530 receives the first position data and determines whether there is any trigger zone data within a threshold area relative to the first position data. If server computer 530 confirms the presence of trigger zone data, server 530 sends a request for more accurate position data.

At 630, computing device 510 receives the request for more accurate geographic position data from server 540.

At 640, computing device 510 determines its current accurate geographic position and sends second position data to server computer 540. The second position data includes the current accurate geographic position of computing device 510. Upon receiving the second position data, server computer 540 sends trigger zone data based on the second position data to computing device 510. In some cases, server computer 540 may send trigger zone data based on the first position data, subscriptions, other geographic regions of a different size, or the like.

At 650, computing device 510 receives (i.e. downloads and/or saves) the trigger zone data from server computer 540. The trigger zone data may include all trigger zone data located within the second position data. In some cases, the trigger zone data is limited to that which was subscribed to or opted into. In other cases, the user can specify or customize trigger zone data delivery based on a number of parameters including geographic area, subscription, trigger zone type, category, or any suitable metric that would be known by one or ordinary skill in the art with the benefit of this disclosure.

At 660, computing device 510 determines whether its current geographic position is within any of the trigger zones (i.e., trigger zone boundaries). If computing device 510 determines that it is not within any trigger zone boundaries, then at 665, computing device 510 stores the trigger zone data and re-evaluates the trigger zones at a later time, at 660.

At 660, if computing device 510 determines that it is within a trigger zone boundary, then, at 670, computing device 510 evaluates the associated trigger zone requirements.

At 680, if computing device 510 determines that the trigger zone requirements have not been met, then, at 665, computing device 510 stores the trigger zone data and, at 660, re-evaluates the trigger zones at a later time, at 660.

At 680, if computing device 510 determines that the trigger zone requirements have been met, then computing device 510 triggers the trigger zone event (i.e., delivers the trigger zone content), at 690. Some non-limiting examples of trigger zone content may include displaying a message (e.g., SMS, e-mail, telematics, push, audio or video cue, phone call, buzz/vibrate, or any suitable notification type), executing a telematics function, and the like.

It should be appreciated that the specific steps illustrated in FIG. 6 provide a particular method of retrieving trigger zone data from a remote server in a power efficient manner, according to an embodiment of the present invention. Other sequences of steps may also be performed according to alternative embodiments. For example, alternative embodiments of the present invention may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of method 600.

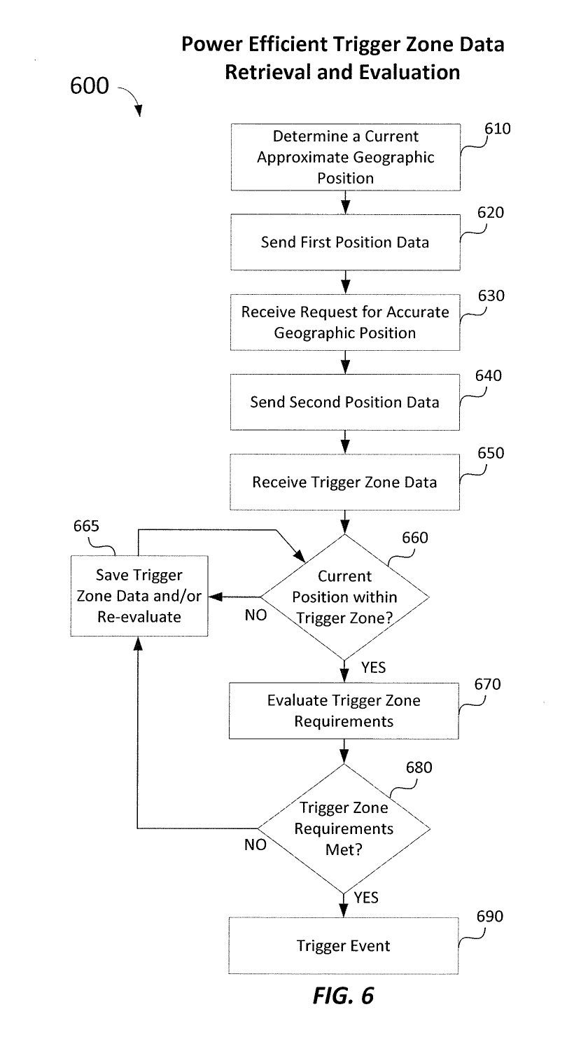

FIG. 7 is a simplified flow diagram illustrating a method 700 for delivering trigger zone data, according to an embodiment of the present invention. Method 700 can be performed by processing logic that may comprise hardware (circuitry, dedicated logic, etc.), software (such as is run on a general purpose computing system or a dedicated machine), firmware (embedded software), or any combination thereof. In one embodiment, method 700 can be performed by the server computer 540 of FIGS. 5A-E.

At 710, method 700 begins with server computer 540 receiving position data from computing device 510. The position data indicates an approximate geographic position of the computing device 510.

At 720, server computer 540 determines whether there are trigger zones present based on the position data. For example, server computer 540 can determine whether any trigger zone boundaries reside within the area defined by the approximate location of the computing device 510 (e.g., a 5 mile radius). If server computer 540 does not detect any trigger zones within the area defined by the approximate location of computing device 510, then no trigger zone data is delivered to computing device 510 and server computer 540 waits for additional position data, at 710.

If the server computer 540 determines that one or more trigger zones are present within the area defined by the approximate location of computing device 510, then, at 730, server computer 540 sends a request to computing device 510 requesting a more accurate geographic position.

At 740, server computer 540 receives additional position data from computing device 510. The additional position data corresponds to a more accurate geographic location of the computing device.

At 750, server computer 540 sends trigger zone data based on the second additional data to computing device 510. In alternative embodiments, server computer 540 may send trigger zone data based on the approximate position data, subscriptions, other geographic areas, trigger zone type, category, or other suitable metric that would be appreciated by one of ordinary skill in the art with the benefit of this disclosure. Server computer 540 may optionally evaluate each trigger zone and deliver trigger zone content to computing device 510 based on the evaluation. For example, the trigger zone evaluation can include determining if the computing device resides within a trigger zone boundary and whether certain trigger zone requirements have been met. In further embodiments, the computing device 510 can perform trigger zone evaluations.

It should be appreciated that the specific steps illustrated in FIG. 4 provide a particular method of retrieving trigger zone data from a remote server, according to an embodiment of the present invention. Other sequences of steps may also be performed according to alternative embodiments. For example, alternative embodiments of the present invention may perform the steps outlined above in a different order. Moreover, the individual steps illustrated in FIG. 4 may include multiple sub-steps that may be performed in various sequences as appropriate to the individual step. Furthermore, additional steps may be added or removed depending on the particular applications. In some embodiments, geo-trigger information (i.e., trigger zone data) can be stored on computing device 510 itself (not server 540), downloaded from the server beforehand, or created and stored locally on computing device 510. In some embodiments, computing device 510 can download geo-trigger content locally to computing device 510 from server 540. In a further embodiment, a user can create geo-trigger content on computing device 510 and store it on computing device 510, not server 510. In such cases, when computing device 510 gets to a location associated that matches a geo-trigger profile (i.e., satisfies the trigger zone requirements), the content is pushed from the local memory on computing device 510 to the user. One of ordinary skill in the art would recognize and appreciate many variations, modifications, and alternatives of method 400.

Dwell Time Analytics

In certain embodiments, dwell time analytics can include a method of creating a data portrait of a user, asset or IP connected device, based on the accumulation and storage of location data by the object's movement or actions in geographical space over time. For example, embodiments of the invention can include dwell time graphs, and/or location-based analytics.

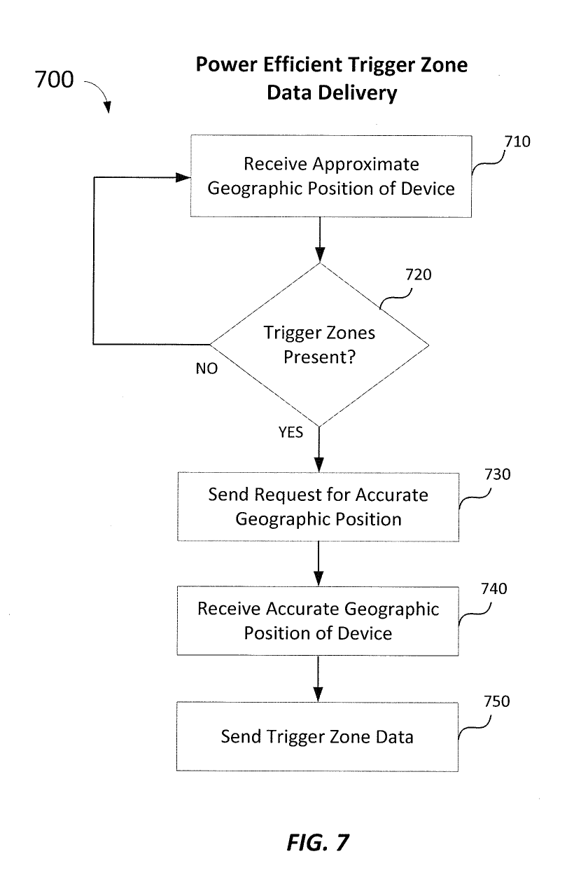

Dwell time analytics can be determined by gathering background location data from opted-in users of electronic devices. For example, users may be subscribed to layers of geo-content, sets of trigger zones subscribed to, and/or created by themselves or third parties. Dwell time analytics can further include determining and analyzing the period of time someone uses a particular software application at a predefined or non-predefined location. For example, a method may include determining a user or IP connected device's place of work or home based on dwell patterns and time spent in a particular region or location. One non-limiting example of a dwell time data log is illustrated in FIG. 8C.

In some embodiments, dwell times can include data related to when a user enters, leaves, or stays in a particular place without that place being pre-defined. For example, a user may have a favorite remote location in the woods that they often frequent. Dwell time analytics can define this particular location as a point of interest and develop a trigger point based on activities related to that location. For example, the user may often frequent several different local convenience stores to pick up paper plates and plastic utensils prior to visiting the remote location. If the purchasing data is available, the computing device 510, server 540, or third party entity may create a custom trigger zone alerts the user that paper plates and plastic utensils are on sale on one particular store as the user enters the trigger zone boundary.

FIG. 8A is a simplified flow diagram illustrating a method 800 for defining a trigger zone based on dwell times, according to an embodiment of the present invention. Method 800 can be performed by processing logic that may comprise hardware (circuitry, dedicated logic, etc.), software (such as is run on a general purpose computing system or a dedicated machine), firmware (embedded software), or any combination thereof. In one embodiment, method 800 can be performed by the computing device 510 configured with IP connectivity. In further embodiments, the method 800 can be performed by the server computer 540, or a combination of both the computing device 510 and server 540.

At 810, method 800 begins with the IP connected computing device 510 (e.g., mobile phone, tablet computer, etc.) determining how long it spends at a particular location or set of locations. The location data can be aggregated and packaged into meaningful data. For example, it may be determined that a large portion of a user's daily activities includes spending time at various coffee shops and restaurants. This data can be organized, utilized, and/or displayed in any suitable format (e.g., spreadsheet, data log, etc.). One non-limiting example of a dwell time based data log is illustrated in FIG. 8C.

At 820, computing device 510 determines a pattern of behavior or demographic profile based on the time spent in the set of locations over time. Patterns can be generated by synthesizing data from the IP-connected computing device 510 with metadata associated with external location-based data sets. For example, if computing device 510 often frequents coffee shops, then that particular computing device can be associated with a coffee shop demographic. In some cases, a user may have an account with multiple IP-connected computing devices. In certain embodiments, the data logs of each computing device can be aggregated, packaged, and associated with each other.

Based on these trends, trigger zones can be created. In the example above, after determining that the user spends a lot of time in coffee shops, a trigger zone can be created that detects when the user is near a coffee shop (e.g., based on travel time) and offers coupons, vouchers, or advertisements when the user enters the trigger zone boundary. It should be noted that this example is non-limiting and trigger zones can be associated with dwell time analytics in any number of ways as would be appreciated by one of ordinary skill in the art with the benefit of this disclosure.

At 830, computing device 510 delivers trigger zone content based on previous behavioral trends. Based on the example above, computing device 510 may display a coupon and barcode for discounted flavors of coffee as the user approaches a previously visited coffee shop.

It should be appreciated that the specific steps illustrated in FIG. 8A provide a particular method of establishing trigger zones based on dwell time analytics, according to an embodiment of the present invention. Other sequences of steps may also be performed according to alternative embodiments. For example, alternative embodiments of the present invention may perform the steps outlined above in a different order. Moreover, the individual steps illustrated in FIG. 8A may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of method 800.

Customizing and Refining Dwell-Time-based Trigger Zones

In certain embodiments, customizing the delivery of trigger zone content that is increasingly relevant to a location can be performed by using user feedback on the trigger zone content presented to them to refine the criteria and algorithms used for sending additional content to a computing device based on current and future locations.

In some embodiments, a user may receive trigger zone data covering wide variety of content, many of which may not be of any interest to the user. One way of selecting preferred trigger zone content is subscribing to or opting into certain trigger zone content or categories thereof. A second way is to track a user's interaction with trigger zone content in a given area. For example, a user may receive a wide variety of trigger zone content for coffee shops, Thai food restaurants, electronics retailers, travel agencies, and the like. The user may frequently interact with the coffee shop and Thai food trigger zone content (i.e., redeem coupons, forward emails, etc.) and mostly ignore the rest. The associated computing device can track that interaction and assign a rank or “gravitational weight” to the trigger zones based on, for example, a type and amount of interaction with the particular trigger zones. Higher ranked trigger zones may have received more user interaction than lower ranked trigger zones. Over time, the computing device can be configured to only deliver content of a certain threshold ranking, thus delivering only that trigger zone content that would most likely be useful and/or interesting to the user.

FIG. 8B is a simplified flow diagram illustrating a method 850 for customizing the delivery of trigger zone content that is increasingly relevant to a location, according to an embodiment of the present invention. Method 850 can be performed by processing logic that may comprise hardware (circuitry, dedicated logic, etc.), software (such as is run on a general purpose computing system or a dedicated machine), firmware (embedded software), or any combination thereof. In one embodiment, method 850 can be performed by computing device 510 configured with IP connectivity. In alternative embodiments, the method 850 can be performed by server computer 540, or a combination of both computing device 510 and server 540.

At 860, method 850 begins with receiving, from a server 540 to a computing device, a wide spread of trigger zone content including a number of different categories.

At 865, computing device 510 ranks user interaction with each of the delivered trigger zone content based on a number of metrics including a response time, the interactive content (e.g., selections clicked, viewed, purchased, shared, etc.).

At 870, computing device 510 assigns a “gravitational weight” based on the quality and amount of these interactions.

At 875, computing device 510 uses the weight assigned to each trigger zone or category thereof to customize and eliminate/add content categories to be sent to the IP connected computing device 510. In some embodiments, trigger zone content or categories ranked below a threshold value will be eliminated from being displayed to the user.

It should be appreciated that the specific steps illustrated in FIG. 8B provide a particular method for customizing the delivery of trigger zone content that is increasingly relevant to a location, according to an embodiment of the present invention. Other sequences of steps may also be performed according to alternative embodiments. For example, alternative embodiments of the present invention may perform the steps outlined above in a different order. Moreover, the individual steps illustrated in FIG. 8B may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of method 850.

In some embodiments, methods can be used to rapidly determine a user's particular interest in trigger zone categories. For example, the computing device 510 may display multiple categories at once and prompt the user to choose their preferred category. As discussed above, metadata can be defined as weighted categories, where each category has a different weight determined algorithmically and based on a user's previous clicks in response to displaying certain content or information. Other secondary considerations that can be used to assign a weight to a particular trigger point category may include a level of interest based on purchases, product recommendations to users and/or other computing devices, comments in social networks, or the like.

In further embodiments, a user's physiological response to trigger zone content can be determined and applied to appropriately weigh that particular trigger zone category. For example, on-board accelerometers or pulse rate detection may be used to determine a user's interest and/or response, as would be appreciated by one of ordinary skill in the art. In yet further embodiments, multiple trigger zone content may be simultaneously displayed with the first trigger zone content being highly unfavorable to the user based on previous selections, and the other being likely favorable, such that the user is inclined to selected the favorable trigger zone content.

In further embodiments, other metrics can be used to define trigger zones and dwell time analytics. For example, a delay time can be set such that after a certain amount of time has elapsed, or before a particular time, a certain action is performed such as an expiration of location data. According to another example, a trigger zone can be created after a user starts moving after having been stopped, without pre-defining the location. Other factors that can be used to create trigger zones based on dwell time analytics can include: dropping or going over a certain speed threshold; changes in altitude; a change in location over cities, states, or countries; changes in categories of places (e.g., airports, hospitals, commercial areas, etc.); changes in locality, region (e.g., rural, urban, etc.), and the like.

Thus, dwell time zones and/or trigger zones can be created in a variety of different ways. Some examples include, but are not limited to, trigger zones can be created from zones pre-selected by the user in the visual trigger editor, by client or administrator. Trigger zones can be programmatically created through the an API using static or dynamic data sets. Furthermore, trigger zones can be created automatically based on dwell time analytics.

Other Uses and Applications of Trigger Zones and Dwell Time Analytics

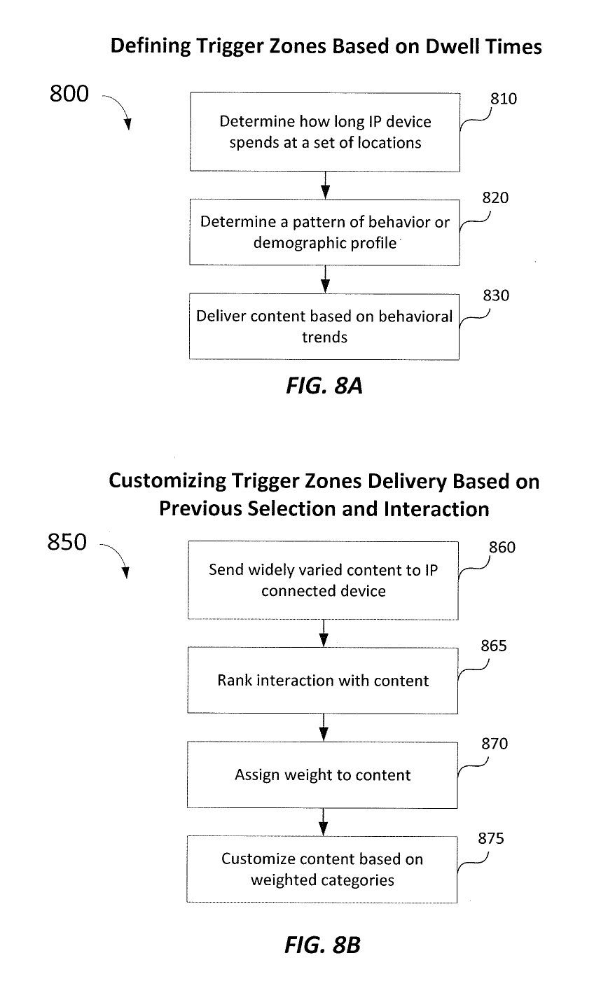

FIG. 9 depicts a dwell time map 900 indicating relative levels of location-based activity from a user or group of users over time, according to an embodiment of the invention. The dwell time map 900 includes sections A905, B 910, C915, D920, E925, F930, G935, H940, 1943, J945, K950, L955, M960, N965, O970, and P975. The shaded areas of the map indicate varying levels of how much time the user has spent in each region over a period of time. Regions 905, 910, 943, and 955 show areas of minimal activity. Regions 935, 930, and 950 show areas of moderate activity. Regions 945, 925, and 920 show areas of great activity. Regions 960, 965, 970 and 975 show areas of no activity. Dwell time map 900 can be an aggregation of a series of automatic location and time-based check-ins made over time, which can be stored in a data base.

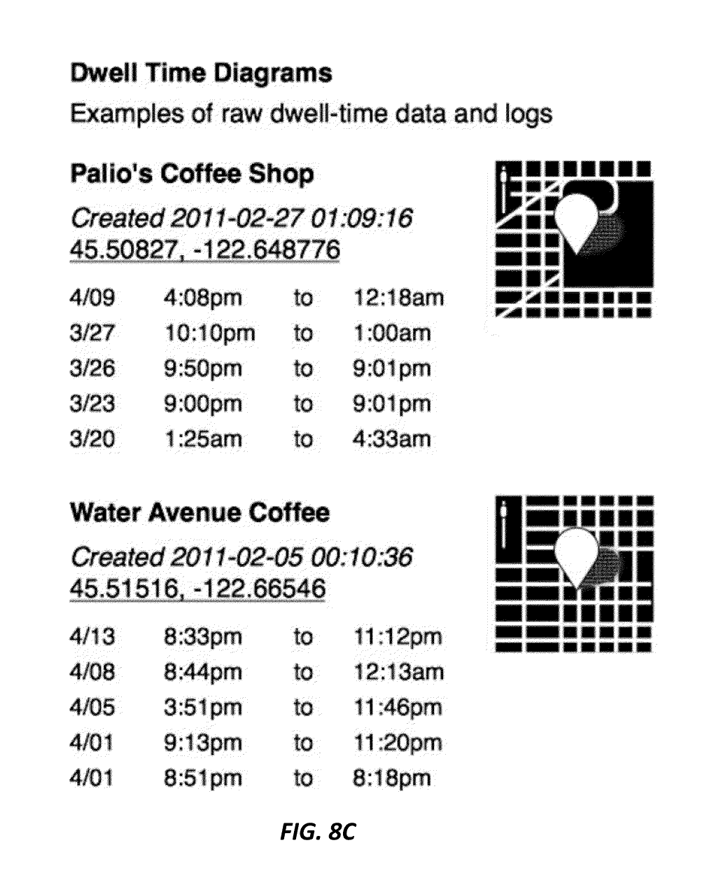

In some embodiments, server computer 540 can be configured to store dwell time data over time and process the data to give meaning to the data. For example, demographic data (e.g., from an external database, from server 540, or the like) can be associated with a user's locations over time to make conclusions about a user's demographic based on the user's dwell-time data. To illustrate, using an external dataset of crime data, a person's risk profile can be determined based on the user's dwell time patterns. In some embodiments, future location trends of a user can be determined based on the user's dwell time patterns. In further embodiments, psychological profiling can be determined based on a user's location patterns. Such patterns and conclusions may include data showing that an at-risk person has not left their house in three days and may be exhibiting signs of depression. In some embodiments, use location data and an external data set can be used to provide suggestions to the user for safer or alternate routes based on user or third party specifications, such as showing travel routes with least crime, least accidents, least pollution, or least chance of flooding. In some cases, a user's location history can be used to warn users of unhealthy patterns of behavior, according to certain embodiments of the invention. Another example of a dwell time map illustrating a number of trigger zones for a user is shown in FIG. 10.

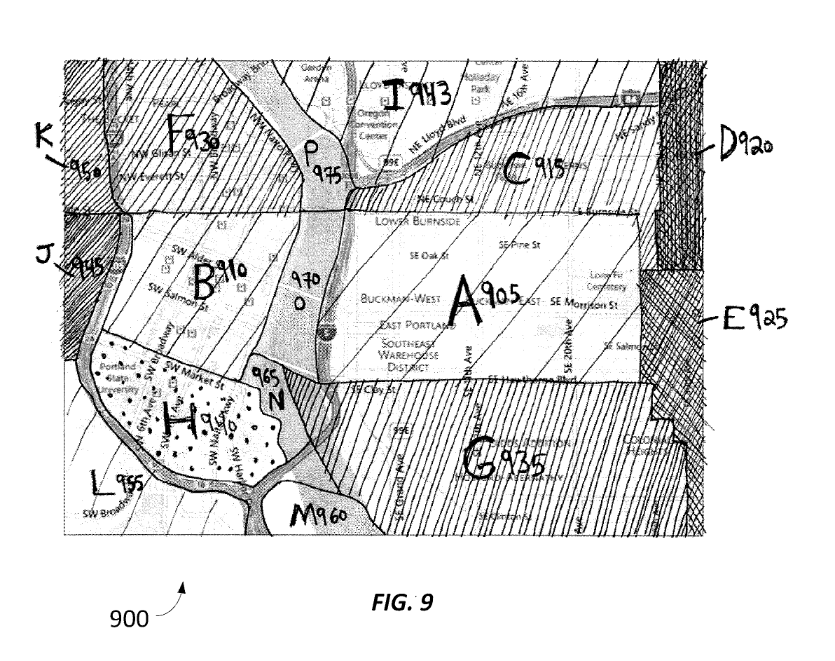

FIG. 11 depicts an application of dwell time analytics on a computing device 1100, according to an embodiment of the invention. In some cases, dwell time analytics and trigger zones can utilized as multi-modal, multi-platform, geo-based event notification systems. In FIG. 11, computing device 1100 (i.e., smart phone) displays dwell time information for the user and a number of associates. For example, the computing device prompts the user to indicate a name of a place that the user was at for three hours. By tracking the locations of various friends and/or colleagues, dwell time patterns can be determined (e.g., particular areas of interest) for each person. As such, dwell time zones and/or trigger zones can inform users of significant social updates. For example, the computing device 1100 (e.g., mobile phone) provides audio feedback indicating that Jake, who is normally in New York, is in town and asks the user if he would like to meet Jake for lunch. It should be noted that FIG. 11 depicts but one use of many possible implementations of dwell time data.

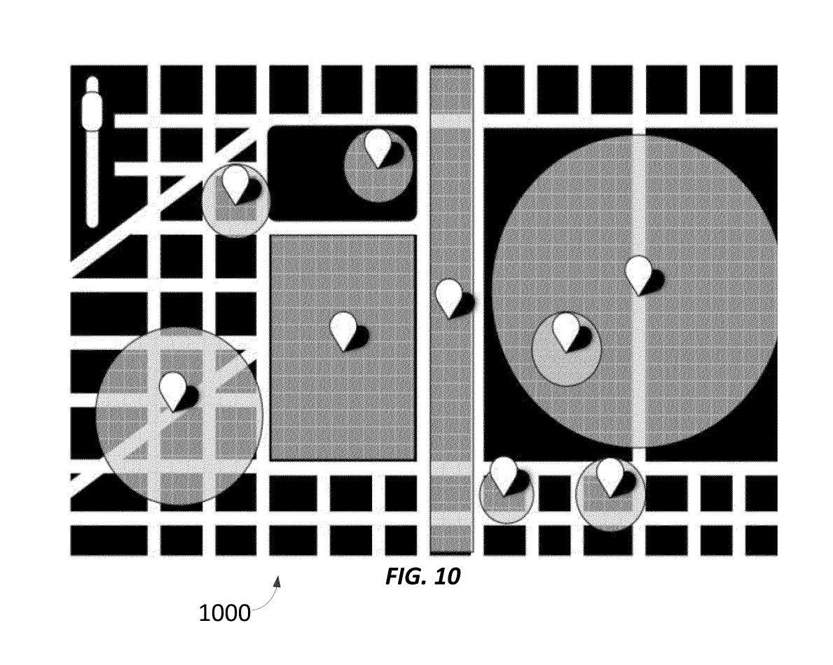

FIG. 12 illustrates a dwell time graph 1200 updated at 5 second intervals, according to an embodiment of the invention. Graph 1200 is yet another representation of dwell time data illustrating very fine-grained data over a large geographic area. It should be noted that embodiments of the invention can use any level of dwell time location data of any level of detail over any size geographic area as required.

Automatic Trigger Zones and Telematics

Trigger zones and dwell time analytics may be used to establish automatic trigger zones. An automatic trigger zone, which can be manually defined by a user, can automatically by a third party service (e.g., from Dwell Time Zones), or programmatically by an API, causing real-world events to be triggered by the sending of messages (i.e., delivering trigger zone content) from the trigger zone server to an IP connected device.

To illustrate automatic trigger zones, a house and associated trigger zone configured to be virtually placed around the house, may be programmed with certain metadata requirements. When the user's computing device matches metadata associated with the trigger zone, a certain action can occur. For example, when a user enters the trigger zone boundary, an automation module in the home may automatically turn on the lights and climate control, based on the trigger zone rules (i.e., trigger zone requirements). Similarly, the automation module may turn the lights and climate control off when the user leaves the trigger zone boundary.

In another embodiment, a trigger zone controlled automation module may trigger a door to unlock when a user enters the trigger zone boundary. In other examples, a computer may authenticate a user, start a predetermined process, or start or stop a timer based on the location of the user with respect to the trigger zone boundary. In some cases, crossing a trigger zone boundary may cause a computing device to display a message of how many minutes away a user is from a particular location. For example, a display configured inside a building could estimate the time away a user is from a building with a real-time trail.

Other applications of trigger zones may include: a user providing a fingerprint to unlock a secure area (i.e., the trigger zone requirements (TZR)) and (a) taking a photo of the user (i.e., trigger zone event (TZE)) while in the secure area (i.e., the trigger zone boundary (i.e., TZB)), (b) turning the lights on in a room (i.e., TZE), or (c) notifying a group chat room when the area is unlocked (i.e., TZE); a motion sensor camera at an entrance or region (i.e., TZB) that sends a photo (i.e., TZE) of anyone that approaches (i.e., TZR); a temperature sensor in a kitchen (i.e., TZB) configured to detect when people are cooking (i.e., TZR) and sending a notification to a database (i.e., TZE); turning on lights (i.e., TZE) in a home (i.e., TZB) when people have arrived (i.e., TZB), where the detection is performed by location services (e.g., GPS) of a phone; using WiFi detection to monitor a device without an application installed to detect their presence in a building or region (e.g., the building infrastructure contains the location sensor rather than the device and can detect the presence of the WiFi devices inside; triggering actions based on temperature sensors in a building (e.g., a trigger zone can be configured with a temperature threshold so that it is only active when the building temperature is above or below a certain threshold; subscribing an IP connected computing device to an area around a building as they approach, and sending an authentication or communication message to the computing device upon their arrival (e.g., authenticating a user based on their physical proximity to a third-party or user-defined trigger zone, for example, to restrict access to files unless the user is physically at the office); and any other implementation as would be appreciated by one of ordinary skill in the art with the benefit of this disclosure.

Certain embodiments of the invention can include a method allowing a user to define a trigger zone or geo-trigger without the use of a GUI or definition on a device of an interface through typing or choosing a previously named geographic place or area. In some embodiments, the selection can be made by voice commands or motion detection (e.g., motion-based commands).

In further embodiments, a method can include sending information or triggering information based on a gravitational method to define alert sites. In such cases, the area of the trigger zone or geo-trigger need not be defined by a line, but bounded by a gravitation field, in which the likelihood of receiving the note is related to an analytic footprint of the users' previous locations, speeds, and interests, etc., in contrast to simply entering into the fixed radius gravitational field of a geo-fence system. The trigger zone can be comprised of media (e.g., a notice, SMS, E-mail, etc.) or an actions (e.g., triggering lights in a home, sending an SMS to another IP connected device, starting a process, etc.).

A trigger zone's gravitational field can be larger or smaller based on metrics provided by user's previous interaction with the system. Some non-limiting examples include how many times a location has been visited, what time of day, what velocity, and the like.

In some embodiments, a user's speed may send them into the gravitational field of the trigger zone or prevents them from receiving the content associated with the trigger zone. For example, a trigger zone having a gravitational field ‘x’ can be configured to deliver a note to a user if they enter a trigger zone within the trigger zone's gravitational field and going ‘y’ miles an hour or less, where y can be a speed predetermined by the owner or administrator of an IP connected device or set of IP connected devices. Certain embodiments need not be a user-selected application on a map, but can be a user selected location based on the user's last set or series of locations, the user's data point entry of a location via an address or other form of location-based data entry, or the user's entry of a search term that is tied to a set of location-based properties or business locations.

In some cases, when content from a trigger zone is delivered, a user device prompts the user to check it off or save it for later for trigger zone persistency. In an embodiment, if a trigger zone is left for person A by person B, the trigger zone content notifies person B (e.g., of computing device B) when person A (e.g., of computing device A) has received the note and the task has been checked off (e.g., a grocery list that everybody in the household contributes to). To support these lists, the trigger zone system can be configured to manage simultaneous updates and assures that multiple people do not buy (or otherwise fulfill) the same list.

Certain embodiments can relate to a method of providing a location-based service. For example, a trigger zone system can provide a user interface that enables a user of an IP connected device to define a trigger zone or Geotrigger at a user-selected distance about a user-selected location. The trigger zone can be graphically indicated by a shaded, patterned, dotted, gradient-filled, or gravitationally-based region on a map, or defined by the user as an address, user-defined name, unnamed region or trigger zone, whose properties are calculated based on a number of user-centric details. Some user-centric details can include time of day, speed of user, previous information entered by user, user's previous interests and data entry, user's previous velocity, or other preferences can be displayed to the user by a user interface.

Some embodiments can be configured to determine a current location of an IP connected device using a location facility of the portable computing device. Some embodiments provide a method including passing the current location to an application server that monitors the current location of the IP connected device with respect to the trigger zone. In response to the application server determining that the current location of the portable electronic device is within the trigger zone, the method includes transmitting instructions to the IP connected device to cause the device to deliver a service to the user.

Certain embodiments can include a set of services that are persistently offered, but delivered when a user meets the criteria of the trigger zone or Geo-trigger. In some cases, when the user is outside the geo-fence, the service is still provided. In other words, certain embodiments may apply a geo-trigger to an existing geo-fence infrastructure. The user-defined service can activate when a user creates a layer or set of geo-content associated with an IP connected device, or chooses the “subscribe” feature on a pre-defined or pre-made third party set of geo-content on a graphic user interface. In some aspects, a user can define more than one geo-gravitational field object, the geo-gravitational field object can be associated with a moving location that is associated with a portable electronic device, and a user interface can be a browser.

Some embodiments include taking an action (e.g., trigger zone event) based on an interaction of an entry within the gravitational field of the geo-gravitational object. Alternatively, actions can be taken based on an interaction of an entity within or nearby a trigger zone. Some actions can include sending an alert when a portable electronic device enters far enough into the gravitational field of the geo-gravitational object to be able to send the message based on the user's velocity, past actions and nearness to the epicenter of the geo-gravitational object.

Some embodiments can include a system for providing a location-based service that may include a user interface that can enable a user of a portable electronic device to define a geo-gravitational site of action or select a location from a predefined list or search. The geo-gravitational object can be indicated by a shaded gravitational field on a map displayed in the user interface. One example of this is shown in FIG. 9 above.

In further embodiments, the user interface can be provided by a computer separate from the portable electronic device, where the user defines the geo-gravitational field on a screen of the computer using a pointing device, where the user sets up an action to be triggered when their device enters into the gravitational field of the geo-gravitational field, or where the user sets up an action to be triggered and sent to another person, when the device enters into the gravitational field of the geo-gravitational field.

In yet further embodiments, a triggered action (e.g., trigger event) can include sending a user generated message to another user's mobile device by way of Email, push notification, text message, online social network, or the like. In some embodiments, the action can be triggered by the creation of a timed link that is sent to another user's mobile device (e.g., push notification, SMS text, online social network, etc.) that allows for the temporary sharing over time. In certain aspects, the creation of the link is not timed.

In certain embodiments, two or more devices can be in the system. For example, the action can be triggered by a set of devices (e.g., device 1 and device 2) when the user of device 1 sets up a user generated geo-gravitational trigger at a geographic location and the portable computing device is the notification of device 1's distance from device 2. The notification can be set up by user of device 1 to be notified of device 2's location via a user specified distance.

In some aspects, a service (e.g., trigger event) offered to the user when within the geo-gravitational field, region, or area, can be the availability of a coupon; the availability of a particular software application; or the availability of a geo-plugin or layer. A layer can be an application written using a given software's API that can be configured to import other functions into the core functionalities of the application, and in some cases can import function written by third parties using third party API's as well.

Some embodiments can provide demographic information associated with portable electronic facilities. In some cases, tracking information may include traffic patterns. Certain embodiments may include a method for effective change on a portable electronic facility in response to location information, such as receiving location information on the portable electronic facility and effecting a change on the portable electronic facility based on the location information. In some aspects, the change may involve a reminder regarding an item on a list (e.g., geo-centric list). The change may involve a change to at least one item on a menu and may affect the availability of an application.

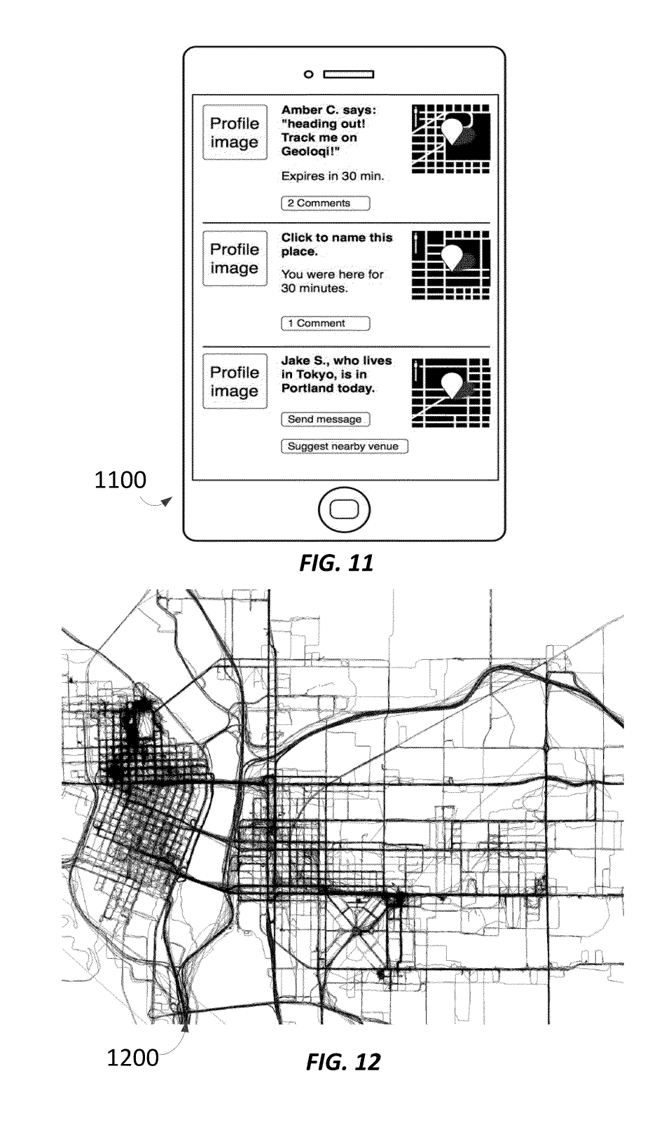

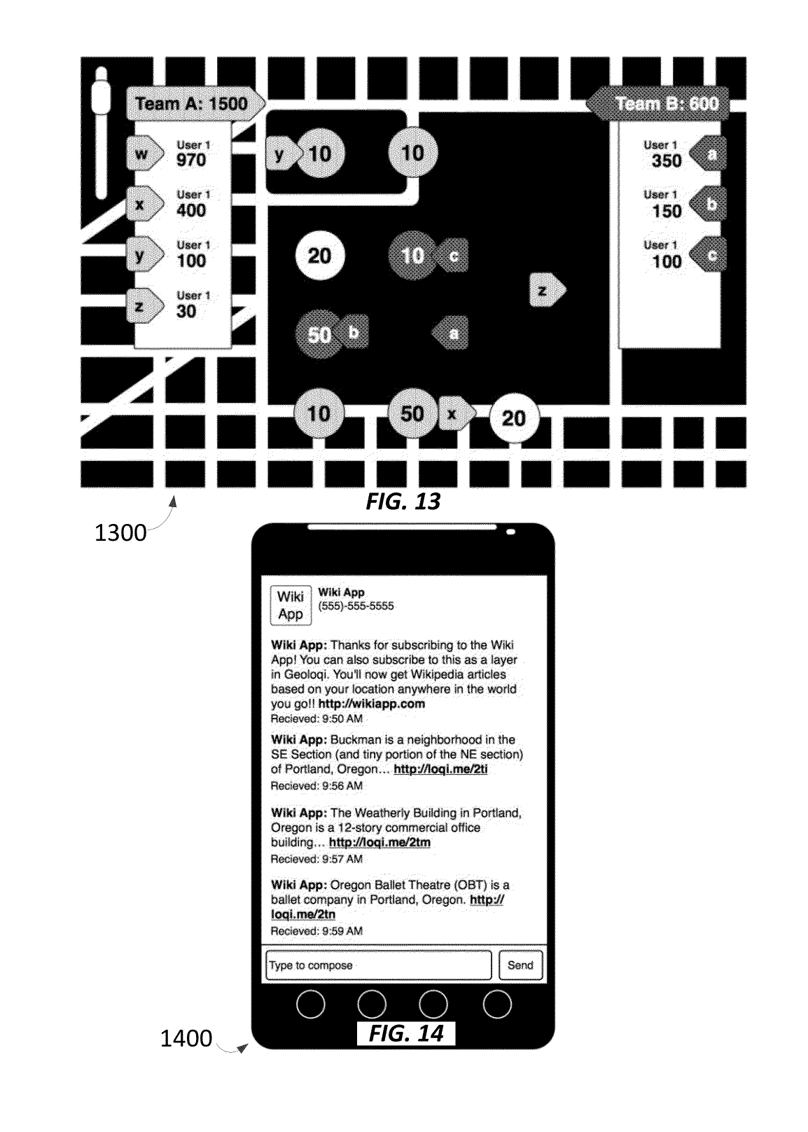

FIG. 13 depicts an image of a trigger-zone-based game 1300, according to an embodiments of the invention. In this example, real-time data is pushed to an opted-in user. The game consists of virtual coins scattered across an area on a map layer. Each coin corresponds to a trigger zone configured in the system. All players are subscribed to the game layer, and the system is aware of the locations of each player. As players intersect the trigger zones, they capture the coin for their team, and the points are added to their score. FIG. 14 displays real-time publically geo-coded data pushed to a user based on their current location, according to an embodiment of the invention.

Geo-Trigger/Trigger Zone Infrastructure and Delivery Systems

In certain embodiments, the trigger zone systems described herein can be operated in a Platform-as-a-Service (PaaS) configuration. PaaS can also include one or more application programming interfaces (API), software development kits (SDK), firmware, software, hardware, servers, and the like, as further discussed and illustrated below. As described above, the systems and methods can be performed in real-time or off-line. They may include battery management capabilities (e.g., see FIGS. 5A-7), geo-triggers, dwell-time analytics capabilities, and storage capabilities (e.g., cloud storage of location data). In some embodiments, users can opt-in or subscribe to “layers” of geo- or trigger-based content, such as a service available to an individual user or set of users that can be created, subscribed to, or activated by the user(s) or administrator of a group of user.

In some embodiments, the communication carried out between entities can be carrier agnostic such that any suitable communication protocol may be used. For example, radio frequency (RF), cellular (e.g., 3G, 4G, or EDGE), Bluetooth, WiFi (IEEE 802.11 family standards), other mobile communication technologies, or combinations thereof can be used. In some cases, there may be wired network connectivity (e.g., Ethernet).

The trigger zone systems discussed herein can be platform agnostic, such that any suitable computing platform can be used to operate the systems and perform the methods described herein. Some computing platforms can include Unix, Linux, Mac OS, Microsoft OS, OS/2, VM, and the like.

In certain embodiments, trigger zone systems can be language agnostic. For example, any suitable programming language can be used to implement the various systems and methods described herein. Some non-liming examples of suitable programming language include Perl, Javascript, C++, Visual Basic, Python, SQL, PHP, or other suitable language.

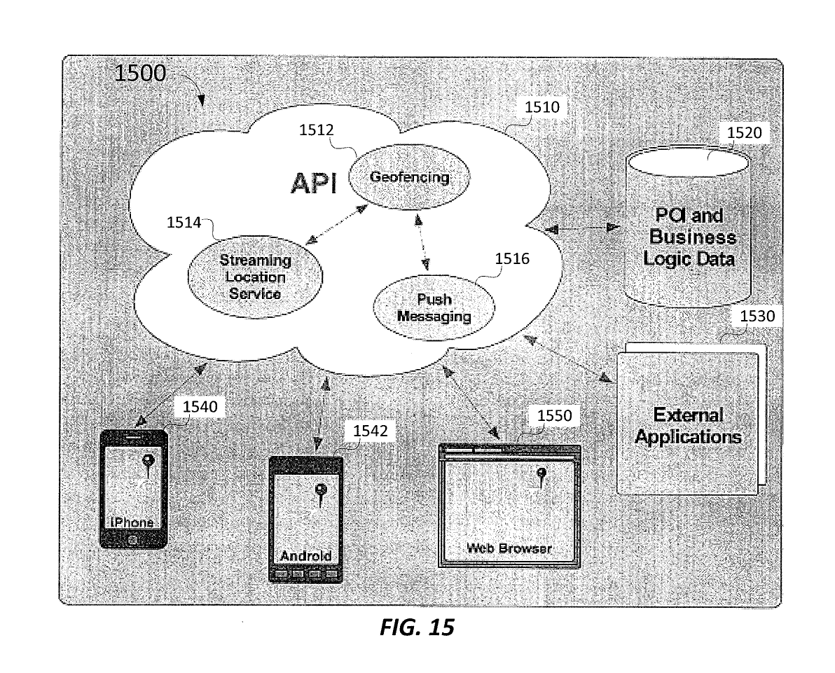

FIG. 15 is a simplified block diagram illustrating aspects of trigger zone system 1500, according to an embodiment of the invention. The trigger zone system 1500 can include an API 1510, computing devices 1540, 1542, and 1550, external applications 1530, and a database 1520. In some cases, the database 1520 can be a database of business names or city/state/region/country names. In certain embodiments, external application 1530 can be an application written by a third-party developer using the system 1500. In further embodiments, the streaming location service 1514 can be an internal component of the API used to stream location data from multiple users to multiple other users, for example, when playing the “MapAttack” game, so that everyone can see where all players are on the map.

An iPhone™ 1540, Android™ 1542, and web browser 1550 are depicted as the computing devices configured to request and receive trigger zone data, however any suitable GPS-capable device can be used. The API can include a streaming location service 1514, geo-fencing and geo-trigger/trigger zone capabilities 1512 (e.g., trigger zone storage, analysis, delivery, etc.), and push messaging capabilities 1516. Other content may be delivered as well, including but not limited to SMS, e-mail, telematics, audio or video cue, phone call, buzz/vibrate, or any suitable notification type, telematics, or other suitable trigger zone event as would be appreciated by one of ordinary skill in the art with the benefit of this disclosure.

According to certain embodiments, the PaaS can include a drop-in modular component that allows for location handling with an external server, battery management, and/or analytics. The Application Programming Interface (API) can provide a location agnostic, carrier agnostic and/or platform agnostic method for cross-communication and location-based communication for IP capable devices.

In some embodiments, a low-level programming language can be used for computing devices to be able to communicate with each other, where location is one of the aspects of communication between the devices, allowing for interoperability of data, triggering of actions and sharing of content between computing devices and users. This can be referred to as an actor network. In addition to location data, geo-content, and/or connectivity data can be used. Location data can be any form of location data, including current location capabilities and future, be it peer to peer mesh networking, indoor beacons, etc. In some embodiments of the invention can include a platform neutral geo-fence software development kit (SDK), or push, or any other web URL hit. It should be noted that the various embodiments described herein (e.g., FIGS. 2B-14) can be implemented using trigger zone system 1500.

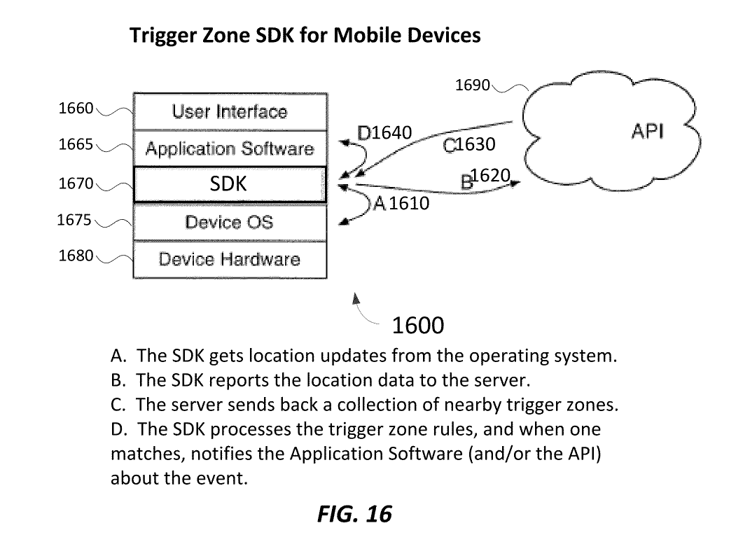

FIG. 16 is a simplified flow diagram illustrating aspects of a method 1600 for retrieving trigger zone data on a mobile device, according to an embodiment of the invention. The mobile device can include a user interface 1660, application software 1665, software development kit (SDK) 1670, device operating system 1675, and device hardware 1680.

At A1610, SDK 1670 receives location updates from the device operating system 1675. For example, the operating system may be simultaneously running GPS tracking software configured to track the current location of the mobile phone at a desired level of accuracy.

At B1620, SDK 1670 reports the location data to the server through API 1690. Server 1690 may be distributed across one or more networks in a cloud, central server network, or the like.

At C1630, if discovered, the server sends back one or more nearby trigger zones to SDK 1670.

At D1640, SDK 1670 processes the trigger zone rules (i.e., trigger zone requirements), and when one matches, that is, when a trigger zone requirement is satisfied, the SDK 1670 notifies application software 1665 (and/or API 1690) about the trigger event.

It should be appreciated that the specific steps illustrated in FIG. 16 provide a particular method of retrieving trigger zone data from a remote server by a mobile phone, according to an embodiment of the present invention. Other sequences of steps may also be performed according to alternative embodiments. For example, alternative embodiments of the present invention may perform the steps outlined above in a different order. Moreover, the individual steps illustrated in FIG. 16 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of method 1600. Furthermore, it should be noted that method 1600, as well as the other embodiments described herein (e.g., FIGS. 2B-14) can be implemented using trigger zone system 1500.

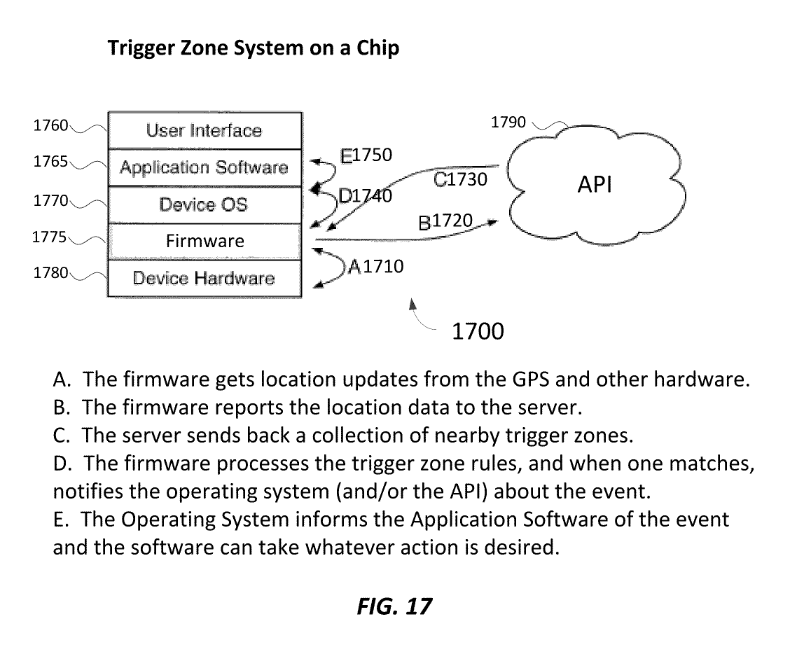

FIG. 17 is a simplified flow diagram illustrating aspects of a method 1700 of retrieving trigger zones on a micro-chip, according to an embodiment of the invention. The micro-chip can include device hardware 1780, firmware 1775, a device operating system 1770, application software 1765, and a user interface 1760.

At A1710, firmware 1775 receives location updates from the GPS and/or other hardware devices 1780.

At B1720, firmware 1775 reports (i.e., sends) the location data to the server 1790. Server 1790 may be distributed across one or more networks in a cloud, central server network, or the like.

At C1730, if discovered, server 1790 sends back a collection of nearby trigger zones to firmware 1775.

At D1740, firmware 1775 processes the trigger zone rules (i.e., trigger zone requirements), and when one matches, that is, when a trigger zone requirement is satisfied, the firmware notifies device operating system 1770 (and/or API 1790) about the trigger event.

At E1750, device operating system 1770 informs application software 1765 of the trigger event and application software 1765 takes a determined action (e.g., trigger zone content delivery).

It should be appreciated that the specific steps illustrated in FIG. 17 provide a particular method of retrieving trigger zone data from a remote server by a micro-chip, according to an embodiment of the present invention. Other sequences of steps may also be performed according to alternative embodiments. For example, alternative embodiments of the present invention may perform the steps outlined above in a different order. Moreover, the individual steps illustrated in FIG. 17 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of method 1700. Furthermore, it should be noted that method 1700, as well as the other embodiments described herein (e.g., FIGS. 2B-14) can be implemented using trigger zone system 1500.

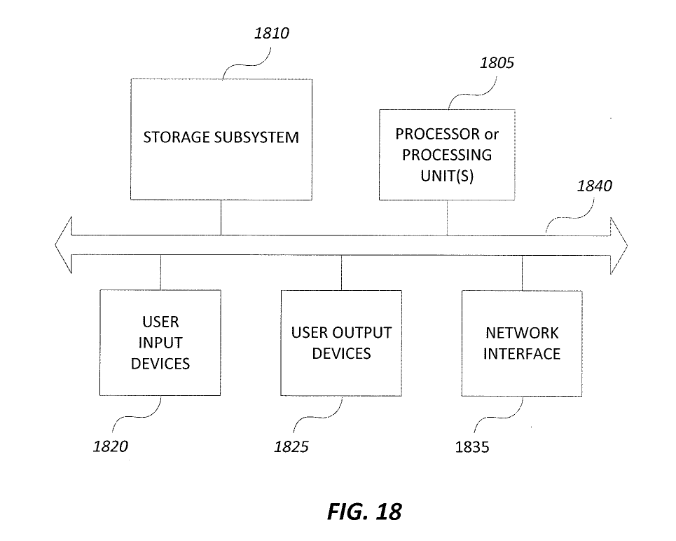

FIG. 18 illustrates a computer system 1800 according to an embodiment of the present invention. The trigger zone retrieval and delivery methods described herein (e.g., FIGS. 3-7) can be implemented within a computer system such as computer system 1800 shown here. For example, computing devices (310, 510) and/or the server computers (340, 540) can utilize computer system 1800. Computer system 1800 can be implemented as any of various computing devices, including, e.g., a desktop or laptop computer, tablet computer, smart phone, personal data assistant (PDA), or any other type of computing device, not limited to any particular form factor. Similarly, computer system 1800 can be implemented on a server computer, computer cluster, or the like. Computer system 1800 can include processing unit(s) 1830, storage subsystem 1810, input devices 1850 (e.g., keyboards, mice, touchscreens, etc.), output devices 1860 (e.g., displays, speakers, tactile output devices, etc.), network interface 1870 (e.g., RF, 4G, EDGE, WiFi, GPS, Ethernet, etc.), and bus 1805 to communicatively couple the various elements of system 1800 to one another.

Processing unit(s) 1830 can include a single processor, multi-core processor, or multiple processors and may execute instructions in hardware, firmware, or software, such as instructions stored in storage subsystem 1810. The storage subsystem 1810 can include various memory units such as a system memory, a read-only memory (ROM), and permanent storage device(s) (e.g., magnetic, solid state, or optical media, flash memory, etc.). The ROM can store static data and instructions required by processing unit(s) 1830 and other modules of system 1800. The system memory can store some or all of the instructions and data that the processor needs at runtime.

In some embodiments, storage subsystem 1810 can store one or more software programs to be executed by processing unit(s) 1830, such as GPS location tracking, sending/receiving location data, sending/receiving trigger zone data, processing trigger zone requirements, delivering trigger zone content, and the like, as further described above with respect to FIGS. 3-7. As mentioned, “software” can refer to sequences of instructions that, when executed by processing unit(s) 1830, cause computer system 1800 to perform certain operations of the software programs. The instructions can be stored as firmware residing in read-only memory and/or applications stored in media storage that can be read into memory for processing by processing unit(s) 1830. Software can be implemented as a single program or a collection of separate programs and can be stored in non-volatile storage and copied in whole or in part to volatile working memory during program execution. From storage subsystem 1810, processing unit(s) 1830 can retrieve program instructions to execute in order to execute various operations (e.g., trigger zone retrieval) described herein.

It will be appreciated that computer system 1800 is illustrative and that variations and modifications are possible. Computer system 1800 can have other capabilities not specifically described here (e.g., mobile phone, global positioning system (GPS), power management, one or more cameras, various connection ports for connecting external devices or accessories, etc.). Further, while computer system 1800 is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software. Furthermore, aspects and/or portions of system 1500 may be implemented using system 1800, as would be appreciated by one of ordinary skill in the art.

While the invention has been described with respect to specific embodiments, one skilled in the art will recognize that numerous modifications are possible. Thus, although the invention has been described with respect to specific embodiments, it will be appreciated that the invention is intended to cover all modifications and equivalents within the scope of the following claims.

The above disclosure provides examples and aspects relating to various embodiments within the scope of claims, appended hereto or later added in accordance with applicable law. However, these examples are not limiting as to how any disclosed aspect may be implemented,

All the features disclosed in this specification (including any accompanying claims, abstract, and drawings) can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, sixth paragraph. In particular, the use of “step of in the claims herein is not intended to invoke the provisions of 35 U.S.C. §112, sixth paragraph.

What is claimed is:

1. A method comprising:
determining, on a computing device, a current geographic position;
sending position data to a server, the position data corresponding to the current geographic position; and
receiving, from the server, one or more trigger zones relevant to the position data, each trigger zone characterized by:
a) a time-based boundary; and
b) one or more requirements to be satisfied to trigger an event.

2. The method of claim 1 further comprising:
determining whether the computing device is located within a time-based boundary of a first trigger zone of the one or more trigger zones;
determining if one or more requirements of the first trigger zone is satisfied; and
triggering an event associated with the first trigger zone.

3. The method of claim 1 wherein the one or more trigger zones are within a threshold area relative to the current geographic position.

4. The system of claim 1 further comprising outputting a notification on the computing device indicating that the one or more requirements has been met.

5. The method of claim 1 wherein each trigger zone includes a reference point and the time-based boundary is defined by an estimated travel time from time-based boundary to the reference point.

6. The method of claim 1 wherein the trigger zones are preselected or subscribed to, such that only those trigger zones that are preselected or subscribed to are received from the server.

7. A computing device comprising:
a processor and a computer-readable storage medium coupled to the processor, the computer readable storage medium comprising code executable by the processor for implementing a method comprising:
determining, on a computing device, a current geographic position;
sending position data to a server, the position data corresponding to the current geographic position; and
receiving, from the server, one or more trigger zones relevant to the position data, each trigger zone characterized by:
a) a time-based boundary; and
b) one or more requirements to be satisfied to trigger an event.

8. The computing device of claim 7 further comprising:
determining whether the computing device is located within a time-based boundary of a first trigger zone of the one or more trigger zones;
determining if one or more requirements of the first trigger zone is satisfied; and
triggering an event associated with the first trigger zone.

9. The computing device of claim 7 wherein the one or more trigger zones are within a threshold area relative to the current geographic position.

10. The computing device of claim 7 further comprising outputting a notification on the computing device indicating that the one or more requirements has been met.

11. The computing device of claim 7 wherein each trigger zone includes a reference point and the time-based boundary is defined by an estimated travel time from time-based boundary to the reference point.

12. A method comprising:
determining, on a computing device, a current approximate geographic position;
sending a first position data to a server, the first position data corresponding to the current approximate geographic position;
receiving, from the server, a request for an accurate geographic position of the computing device;
determining, on a computing device, a current accurate geographic position, the current accurate geographic position being more accurate than the approximate geographic position;
sending a second position data to a server, the second position data corresponding to the current accurate geographic position; and
receiving, from the server, one or more trigger zones relevant to the position data, each trigger zone characterized by:
a) a time-based boundary; and
b) one or more requirements to be satisfied to trigger an event.

13. The method of claim 12 further comprising:
determining whether the computing device is located within a time-based boundary of a first trigger zone of the one or more trigger zones;
determining if one or more requirements of the first trigger zone is satisfied; and
triggering an event associated with the first trigger zone.

14. The method of claim 12 wherein the one or more trigger zones are within a threshold area relative to the current geographic position.

15. A method comprising:
receiving position data from a computing device, the position data corresponding to a current geographic position of the computing device;
determining whether one or more trigger zones are within a threshold area relative to the position data; and
sending trigger zone data to the computing device, the trigger zone data including one or more trigger zones with the threshold area relative to the position data, each trigger zone characterized by:
a) a time-based boundary; and
b) one or more requirements to be satisfied to trigger an event.

16. The method of claim 16 further comprising:
determining how much time the computing device spends at one or more geographic locations; and
generating a dwell-time trigger zone including dwell-time trigger zone data based on:
a) an amount of time spent at the geographic location; and
b) location based data associated with the geographic location, the location based data corresponding to commercial aspects particular to the geographic location, wherein sending trigger zone data to the computing device further includes sending dwell-time trigger zone data.

17. The method of claim 15 wherein the one or more requirements include digital content configured to be interacted with via the computing device, and wherein the method further comprises:
detecting an amount of interaction made by the computing device for each of the trigger zones; and
assigning each of the one or more trigger zones with a weighted value based on the amount of interaction, wherein higher weighted values indicate higher amounts of interaction, wherein lower weighted values indicate lower amounts of interaction, and wherein the trigger zone data further includes only sending trigger zones above a threshold weighted value to the computing device.

18. A server computer comprising:
a processor and a computer-readable storage medium coupled to the processor, the computer readable storage medium comprising code executable by the processor for implementing a method comprising:
receiving position data from a computing device, the position data corresponding to a current geographic position of the computing device;
determining whether one or more trigger zones are within a threshold area relative to the position data; and
sending trigger zone data to the computing device, the trigger zone data including one or more trigger zones with the threshold area relative to the position data, each trigger zone characterized by:
a) a time-based boundary; and
b) one or more requirements to be satisfied to trigger an event.

19. The server computer of claim 18 determining how much time the computing device spends at one or more geographic locations; and
generating a dwell-time trigger zone including dwell-time trigger zone data based on:
a) an amount of time spent at the geographic location; and
b) location based data associated with the geographic location, the location based data corresponding to commercial aspects particular to the geographic location, wherein sending trigger zone data to the computing device further includes sending dwell-time trigger zone data.

20. A method comprising:
receiving, from a computing device, first position data from a computing device, the first position data corresponding to a current approximate geographic position of the computing device;
determining whether one or more trigger zones are within a threshold area relative to the first position data;
sending, to the computing device, a request for an accurate geographic position of the computing device;
receiving, from the computing device, second position data, the second position data corresponding to a current accurate geographic position of the computing device;
sending trigger zone data to the computing device, the trigger zone data including one or more trigger zones with the threshold area relative to the second position data, each trigger zone characterized by:
a) a time-based boundary; and
b) one or more requirements to be satisfied to trigger an event.
